(19) United States
(12) Patent Application Publication
(10) Pub. No.: US 2025/0110976 A1
(43) Pub. Date: Apr. 3, 2025

(54) NATURAL LANGUAGE INTERFACE FOR IDENTITY MANAGEMENT DATA MINING USING GENERATIVE AI

(71) Applicant: OKTA, INC., SAN FRANCISCO, CA (US)

(72) Inventors: Vrushali Vasudeo CHANNAPATTAN, Fremont, CA (US); Baoxian ZHAO, Annandale, VA (US); Gregory Darrell FEE, Seattle, WA (US); RajeshDutta ShyamDeva MISHRA, Bellevue, WA (US); Mohammadamin JASHKI, Toronto (CA); Daniel Edwards DENNHARDT, Philadelphia, PA (US); Zhao WANG, Toronto (CA)

(21) Appl. No.: 18/824,518

(22) Filed: Sep. 4, 2024

Related U.S. Application Data
(60) Provisional application No. 63/587,619, filed on Oct. 3, 2023.

(51) Int. Cl. G06F 16/332; G06F 16/33; G06F 16/338; G06F 40/205

(52) U.S. Cl. CPC G06F 16/3329; G06F 16/3337; G06F 16/338; G06F 40/205

(57) ABSTRACT

Methods, systems, and devices for processing a natural language request are described. An identity management system may receive a user request for information maintained in the identity management system and related to a client organization. The request may be received in a natural language form. In response to the user request, a machine learning model may be employed to generate a query in a machine-readable language that is understandable by the identity management system. The model-generated query, when executed, may cause information responsive to the user's request to be retrieved and output for display. Based on receiving a selection of a portion of the information output for display, the machine learning model may be employed to generate a natural language explanation of the selected portion. In some cases, the natural language explanation may be a summarization of information associated with the selected portion and retrieved from multiple data sources.

### CROSS REFERENCE TO RELATED APPLICATIONS

This application is a continuation of and claims priority to U.S. Provisional Patent Application No. 63/587,619, filed Oct. 3, 2023, and entitled “NATURAL LANGUAGE INTERFACE FOR IDENTITY MANAGEMENT DATA MINING USING GENERATIVE AI,” which is incorporated herein by reference in its entirety.

### FIELD OF TECHNOLOGY

The present disclosure relates generally to identity management, and more specifically to a natural language interface for identity data management mining using generative AI.

### BACKGROUND

An identity management system may be employed to manage and store various forms of user data, including usernames, passwords, email addresses, permissions, roles, group memberships, etc. The identity management system may provide authentication services for applications, devices, users, and the like. The identity management system may enable client organizations to manage and control access to resources, for example, by serving as a central repository that integrates with various identity sources. The identity management system may provide an interface that enables users to access a multitude of applications with a single set of credentials.

The identity management system may maintain a variety of data in a variety of data sources encompassing the breadth of the identity management services provided to the client organizations. Such data may include, but may not be limited to, information about the client organizations' users, authentication policies, sign on events, system configuration, system errors, or the like. The data may also include knowledge-based data such as documentation, guides, configuration instructions, or the like. Such data may be stored in databases and files across various devices, services, and networks. Such data may be useful to administrators of the client organizations for resolving issues or better understanding their system environment as it relates to the identity management system. However, administrators may not have way to easily access such data as they may not know precisely what data exists, where it is stored, or how to access it.

### SUMMARY

The described techniques relate to improved methods, systems, devices, and computer-readable media that support a natural language interface of identity management data mining using generative AI. For example, the described techniques provide a framework for using generative AI to generate a machine-readable query to retrieve identity management data in response to a natural language user query. In some examples, an identity management system may receive a request for information related to a client organization and maintained in the identity management system. The request may be received in a natural language form, such as “how many users logged into Application A yesterday?” In response to the request, the identity management system may employ a machine learning model to generate a query in a machine-readable language that is understandable by the identity management system. For example, the query may be generated in a database programming language. The model-generated query, when executed, may cause information responsive to the user's request to be retrieved and output for display. In some cases, the user may select a portion of the information output, such as one or more records, data elements, images, links, etc. to receive a further explanation about the selected portion. In response to the selection, the machine learning model may be employed to generate, based on the selected portion, a natural language explanation of the selected portion. In some cases, the natural language explanation may be a summarization of information associated with the selected portion and retrieved from multiple data sources.

A method of an identity management system is described. The method may include receiving, from a client device associated with a client organization, a natural language user query, where the natural language user query includes a request for information related to configuration data or a system event occurring in the identity management system and associated with the client organization, generating, based on the natural language user query and using a machine learning model, a model-generated machine-readable query, where the model-generated machine-readable query is generated in a machine-readable language associated with the identity management system, retrieving, based on executing the model-generated machine-readable query, information responsive to the natural language user query, and outputting the information responsive to the natural language user query.

An identity management device is described. The device may include one or more memories storing processor executable code, and one or more processors coupled with the one or more memories. The one or more processors may individually or collectively be operable to execute the code to cause the device to receive, from a client device associated with a client organization, a natural language user query, where the natural language user query includes a request for information related to configuration data or a system event occurring in an identity management system and associated with the client organization, generate, based on the natural language user query and using a machine learning model, a model-generated machine-readable query, where the model-generated machine-readable query is generated in a machine-readable language associated with the identity management system, retrieve, based on executing the model-generated machine-readable query, information responsive to the natural language user query, and output the information responsive to the natural language user query.

Another identity management device is described. The device may include means for receiving, from a client device associated with a client organization, a natural language user query, where the natural language user query includes a request for information related to configuration data or a system event occurring in an identity management system and associated with the client organization, means for generating, based on the natural language user query and using a machine learning model, a model-generated machine-readable query, where the model-generated machine-readable query is generated in a machine-readable language associated with the identity management system, means for retrieving, based on executing the model-generated machine-readable query, information responsive to the natural language user query, and means for outputting the information responsive to the natural language user query.

A non-transitory, computer-readable medium storing code is described. The code may include instructions executable by a processor to receive, from a client device associated with a client organization, a natural language user query, where the natural language user query includes a request for information related to configuration data or a system event occurring in an identity management system and associated with the client organization, generate, based on the natural language user query and using a machine learning model, a model-generated machine-readable query, where the model-generated machine-readable query is generated in a machine-readable language associated with the identity management system, retrieve, based on executing the model-generated machine-readable query, information responsive to the natural language user query, and output the information responsive to the natural language user query.

In some examples of the method, devices, and non-transitory computer-readable medium described herein, the machine-readable language includes a reporting query language (RQL), a database query language, or an expression language.

In some examples of the method, devices, and non-transitory computer-readable medium described herein, the database query language includes Structured Query Language (SQL).

In some examples of the method, devices, and non-transitory computer-readable medium described herein, the expression language includes OKTA Expression Language (EL), System for Cross-domain Identity Management (SCIM) filter expression, regular expression.

In some examples of the method, devices, and non-transitory computer-readable medium described herein, the model-generated machine-readable query may be generated in a first machine-readable language and the method, devices, and non-transitory computer-readable medium may include further operations, features, means, or instructions for outputting the model-generated machine-readable query in the first machine-readable language, receiving an indication of a modification to the model-generated machine-readable query, translating the modified model-generated machine-readable query from the first machine-readable language to a second machine-readable language, and where retrieving the information responsive to the natural language user query includes retrieving, based on executing the modified model-generated machine-readable query in the second machine-readable language, the information responsive to the natural language user query.

Some examples of the method, devices, and non-transitory computer-readable medium described herein may further include operations, features, means, or instructions for outputting the model-generated machine-readable query in the first machine-readable language may be in response to receiving an indication of a user selection to view the model-generated machine-readable query.

In some examples of the method, devices, and non-transitory computer-readable medium described herein, the translating includes compiling the modified model-generated machine-readable query in the first machine-readable language to generate the modified model-generated machine-readable query in the second machine-readable language.

In some examples of the method, devices, and non-transitory computer-readable medium described herein, the first machine-readable language includes RQL.

In some examples of the method, devices, and non-transitory computer-readable medium described herein, the second machine-readable language includes SQL.

In some examples of the method, devices, and non-transitory computer-readable medium described herein, the model-generated machine-readable query, when executed, retrieves the information from one or more: system logs, security logs, configuration logs, analytics logs, threat logs, management logs, machine access logs, browser activity logs, extended detection and response (XDR) logs, error logs, mobile device management (MDM) logs, database tables, or files.

In some examples of the method, devices, and non-transitory computer-readable medium described herein, the retrieved information includes the information related to the configuration data or the system event occurring in the identity management system.

In some examples of the method, devices, and non-transitory computer-readable medium described herein, the model-generated machine-readable query, when executed, retrieves the information from one or more report tables.

In some examples of the method, devices, and non-transitory computer-readable medium described herein, the one or more report tables include the information related to the configuration data or the system event occurring in the identity management system.

In some examples of the method, devices, and non-transitory computer-readable medium described herein, prior to generating the model-generated machine-readable query, pre-processing the natural language user query and where generating the model-generated machine-readable query includes generating, based on the pre-processed natural language user query and using the machine learning model, the model-generated machine-readable query.

In some examples of the method, devices, and non-transitory computer-readable medium described herein, the pre-processing may include operations, features, means, or instructions for parsing the natural language user query to determine whether the natural language user query includes: language that may be potentially malicious, or language that violates a constraint configured by the identity management system.

Some examples of the method, devices, and non-transitory computer-readable medium described herein may further include operations, features, means, or instructions for removing the determined language.

Some examples of the method, devices, and non-transitory computer-readable medium described herein may further include operations, features, means, or instructions for outputting a notification indicating removal of the determined language.

Some examples of the method, devices, and non-transitory computer-readable medium described herein may further include operations, features, means, or instructions for rejecting the natural language user query.

Some examples of the method, devices, and non-transitory computer-readable medium described herein may further include operations, features, means, or instructions for outputting a notification indicating rejection of the natural language user query.

In some examples of the method, devices, and non-transitory computer-readable medium described herein, the pre-processing may include operations, features, means, or instructions for parsing the natural language user query to identify personally-identifiable information, replacing the personally-identifiable information with a placeholder value, and caching the personally-identifiable information.

In some examples of the method, devices, and non-transitory computer-readable medium described herein, the pre-processing may include operations, features, means, or instructions for selecting, based on the natural language user query, one or more prompts and embedding the natural language user query within the one or more prompts or embedding the one or more prompts in the natural language query.

In some examples of the method, devices, and non-transitory computer-readable medium described herein, selecting the one or more prompts may include operations, features, means, or instructions for determining an intent associated with the natural language user query and selecting the one or more prompts further based on the determined intent associated with the natural language user query.

In some examples of the method, devices, and non-transitory computer-readable medium described herein, a first prompt, of the one or more prompts, causes the machine learning model to generate the model-generated machine-readable query to query one or more: system logs, security logs, configuration logs, analytics logs, threat logs, management logs, machine access logs, browser activity logs, extended detection and response (XDR) logs, error logs, mobile device management (MDM) logs, database tables, or files.

Some examples of the method, devices, and non-transitory computer-readable medium described herein may further include operations, features, means, or instructions for prior to executing the model-generated machine-readable query, post-processing the model-generated machine-readable query and where executing the model-generated machine-readable query includes executing the post-processed model-generated machine-readable query.

In some examples of the method, devices, and non-transitory computer-readable medium described herein, the pre-processing may include operations, features, means, or instructions for replacing the placeholder value with the cached personally-identifiable information.

In some examples of the method, devices, and non-transitory computer-readable medium described herein, the pre-processing may include operations, features, means, or instructions for validating, based at least in part on a syntax associated with the machine-readable language and a schema associated with a database associated with the identity management system, the model-generated machine-readable query.

In some examples of the method, device, and non-transitory computer-readable medium described herein, the information responsive to the natural language user query includes one or more portions and the method, devices, and non-transitory computer-readable medium may include further operations, features, means, or instructions for receiving a user selection of at least one portion of the one or more portions, generating, based on the at least one portion and using the machine learning model, a natural language explanation of the at least one portion, and outputting the natural language explanation of the at least one portion.

In some examples of the method, device, and non-transitory computer-readable medium described herein, the information responsive to the natural language user query includes one or more portions and the method, devices, and non-transitory computer-readable medium may include further operations, features, means, or instructions for receiving a user selection of a plurality of portions of the one or more portions, generating, based on the plurality of portions and using the machine learning model, a natural language explanation of the plurality of portions, and outputting the natural language explanation of the plurality of portions.

In some examples of the method, device, and non-transitory computer-readable medium described herein, the at least one portion includes a record, a data element, an image, or a combination thereof.

In some examples of the method, device, and non-transitory computer-readable medium described herein, generating the natural language explanation of the at least one portion includes generating a second model-generated machine-readable query, executing the second model-generated machine-readable query to retrieve, from one or more data sources, information associated with the at least one portion, causing summarization of the retrieved information associated with the at least one portion, and generating the natural language explanation of the at least one portion based at least in part on the summarized information associated with the at least one portion.

In some examples of the method, devices, and non-transitory computer-readable medium described herein, the natural language explanation includes a summarization of information associated with the at least one portion and retrieved from a set of multiple data sources.

In some examples of the method, devices, and non-transitory computer-readable medium described herein, prior to generating the natural language explanation of the at least one portion, pre-processing the at least one portion, where generating the natural language explanation of the at least one portion includes generating, based on the pre-processed at least one portion and using the machine learning model, the natural language explanation of the at least one portion.

In some examples of the method, devices, and non-transitory computer-readable medium described herein, pre-processing the at least one portion may include operations, features, means, or instructions for analyzing the at least one portion to determine a context associated with the at least one portion.

In some examples of the method, devices, and non-transitory computer-readable medium described herein, pre-processing the at least one portion may include operations, features, means, or instructions for parsing the at least one portion to identify personally-identifiable information, replacing the personally-identifiable information with a placeholder value, and caching the personally-identifiable information.

In some examples of the method, devices, and non-transitory computer-readable medium described herein, prior to outputting the natural language explanation of the at least one portion, replacing the placeholder value with the cached personally-identifiable information.

In some examples of the method, devices, and non-transitory computer-readable medium described herein, the pre-processing may include operations, features, means, or instructions for selecting, based on the at least one portion, one or more prompts and prepending the at least one portion with the one or more prompts.

In some examples of the method, devices, and non-transitory computer-readable medium described herein, selecting the one or more prompts may include operations, features, means, or instructions for determining a context associated with the at least one portion and selecting the one or more prompts further based on the determined context associated with the at least one portion.

In some examples of the method, devices, and non-transitory computer-readable medium described herein, a second prompt, of the one or more prompts, causes the machine learning model to generate a natural language response.

Some examples of the method, devices, and non-transitory computer-readable medium described herein may further include operations, features, means, or instructions for based on receiving a second natural language user query after outputting the information responsive to the natural language user query, training the machine learning model using the natural language user query and the second natural language user query.

In some examples of the method, devices, and non-transitory computer-readable medium described herein, the second natural language user query may be received within a predetermined amount of time after outputting the information responsive to the natural language user query.

Some examples of the method, devices, and non-transitory computer-readable medium described herein may further include operations, features, means, or instructions for training the machine learning model to translate a natural language query into a machine-readable query.

In some examples of the method, devices, and non-transitory computer-readable medium described herein, the information responsive to the natural language user query includes information associated with identity management data associated with the client organization, information associated with resources of the client organization, information associated with users of the client organization, information associated with groups associated with the client organization, information associated with access events associated with the client organization, information associated with authorization events associated with the client organization, information associated with a system configuration associated with the client organization, or any combination thereof.

### BRIEF DESCRIPTION OF THE DRAWINGS

FIG. 1 illustrates an example of a computing system that supports a natural language interface for identity management data mining using generative AI in accordance with aspects of the present disclosure.

FIGS. 2 and 3 show examples of system architectures that support a natural language interface for identity management data mining using generative AI in accordance with aspects of the present disclosure.

FIG. 4 shows an example of a system architecture that supports training a generative AI system to support a natural language interface for identity management data mining in accordance with aspects of the present disclosure.

FIG. 5 shows an example of capabilities of a generative AI system that supports a natural language interface for identity management data mining in accordance with aspects of the present disclosure.

FIG. 6 shows an example of a protocol that supports a natural language interface for identity management data mining using generative AI in accordance with aspects of the present disclosure.

FIG. 7 shows a block diagram of an device that supports natural language interface for identity data mining using generative AI in accordance with aspects of the present disclosure.

FIG. 8 shows a block diagram of a software module that supports natural language interface for identity data mining using generative AI in accordance with aspects of the present disclosure.

FIG. 9 shows a diagram of a system including a device that supports natural language interface for identity data mining using generative AI in accordance with aspects of the present disclosure.

FIGS. 10 through 12 show flowcharts illustrating methods that support a natural language interface for identity data management mining using generative AI in accordance with aspects of the present disclosure.

### DETAILED DESCRIPTION

Cloud computing provides for the delivery of computing services or resources over the Internet. These services and resources may include software applications, data storage, databases, servers, virtual machines, operating systems, analytics, computing environments or platforms, authentication services, etc. Some organizations may use cloud computing to increase performance, manage computing and operating costs, provide for on-demand scalability of computing resources, improve reliability, and many other reasons. However, the use of cloud computing may present certain security vulnerabilities. As such, in order to ensure the security of an organization's cloud resources, and in some cases the organization's on-premises resources as well, the organization may use one or more tools to control access to the organization's resources (e.g., control what resources particular users are permitted to access, and what the users can do with the resources that they are permitted to access).

For example, when a user of an organization (e.g., an employee of the organization) wishes to access the organization's resources, the user may be requested to log into an account associated with the organization. The user may provide user credentials, such as a combination of a username and a password or other information. The system may use the user credentials as authentication information to verify an identity of the user. Once authenticated, the system may determine whether the user has been granted permission or privileges to access the requested resources.

In some cases, to alleviate a burden on an organization, the organization may employ a service provider, such as an identity management service provider, to provide identity and access management services on behalf of the organization. In such cases, the identity management service provider may provide the identity and access management service to the organization as well as to other organizations. The multiple organizations may be clients of the identity management service provider and the identity management service provider may maintain an identity management system to manage the identities and access privileges of the users of the different client organizations on behalf of those client organizations.

In some cases, the identity management system may provide one or more tools or services that enable administrators of the client organizations to interact with the identity management system to ask questions or to otherwise inquire about aspects of the identity management system or the client organizations' system configurations, events, errors, users, or the like associated with the identity management system. Conventionally, client organization administrators might have to receive assistance from an administrator of the identity management system or might have to browse through various logs, files, online sources (both internal and external to the identity management system), run canned reports, and the like to attempt to uncover answers to such inquiries. Such efforts may be time consuming and often do not result in obtaining the most accurate information.

In accordance with aspects described herein, the identity management system may leverage identity management data from its various client organizations, and maintained by the identity management system, to employ a machine learning model, such as a large language model, to translate a natural language user query into a machine-readable query that may be executed by the identity management system to access or query one or more data sources maintained by the identity management system to retrieve information responsive to the user's query. For instance, an administrator of a client organization may access a natural language user interface of the identity management system, such as a chat box interface, to submit a question for information associated with the client organization. For example, the natural language question may be a question such as “how many users logged into App A last month?,” “have I been subject to a large-scale credential attack?,” “show me all the activity this is related to User B,” “which users accessed App B and what were their authenticator assurance levels,” or “what administrative changes have been made recently?” In response to receiving the natural language query the identity management system may use a machine learning model to generate a machine-readable query in a machine-readable language that is associated with the identity management system. The identity management system may execute the model-generated query to obtain information from one or more sources maintained by the identity management system and responsive to the user's query. The information may be output via the natural language user interface. In some cases, the administrator may select at least a portion of the information output in response to the user's query and the machine learning model may again be employed to generate further or more detailed information associated with the selected portion. The further information may in some cases be information retrieved from a plurality of sources, and the identity management system may distill or summarize the retrieved information in a manner that may be easier for the administrator to consume. The summary of the further information may be output via the natural language user interface.

The described techniques provide a simplified and streamlined way for administrators of client organizations to conveniently access information maintained in the identity management system about their client organization, thereby improving the user experience and ensuring that the client organizations are able to access the most accurate and up-to-date information. Further, by employing a machine learning model to generate machine-readable queries to retrieve information responsive to a user's query, the identity management system may avoid receiving queries written and executed by administrators who may issue queries that are poorly written or not optimized for the identity management system's databases. Executing such queries may result in long running queries that degrade performance at the identity management system.

Aspects of the disclosure are initially described in the context of a computing system. Aspects of the disclosure are further illustrated by and described with reference to various diagrams and flowcharts that relate to techniques for generating policy recommendations and insights using generative AI.

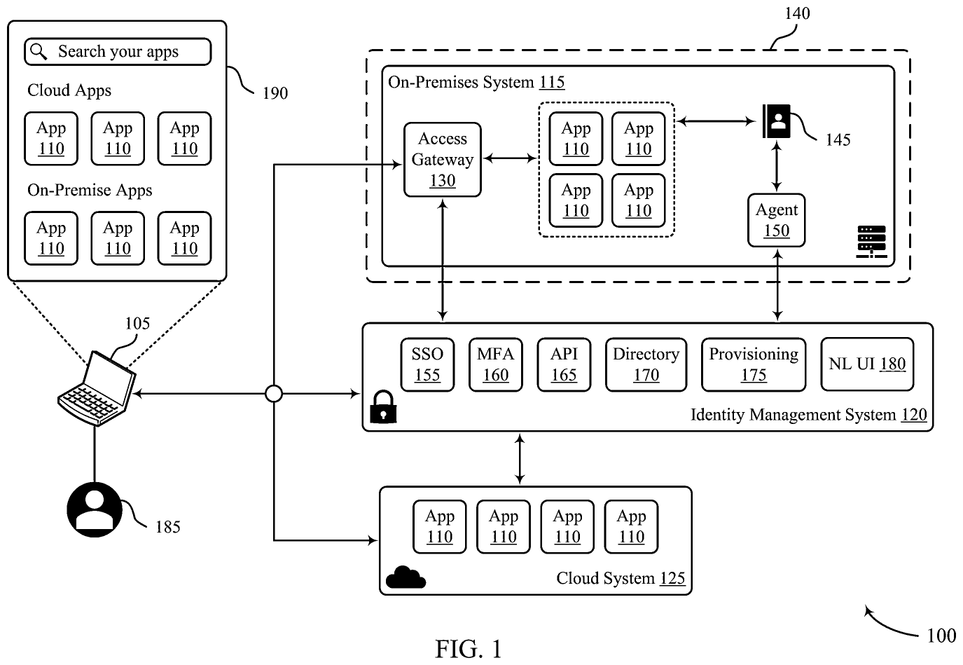

FIG. 1 illustrates an example of a computing system 100 that supports a natural language interface for identity data management mining using generative AI in accordance with various aspects of the present disclosure. The computing system 100 includes a computing device 105 (such as a desktop, laptop, smartphone, tablet, or the like), an on-premises system 115, an identity management system 120, and a cloud system 125, which may communicate with each other via a network, such as a wired network (e.g., the Internet), a wireless network (e.g., a cellular network, a wireless local area network (WLAN)), or both. In some cases, the network may be implemented as a public network, a private network, a secured network, an unsecured network, or any combination thereof. The network may include various communication links, hubs, bridges, routers, switches, ports, or other physical and/or logical network components, which may be distributed across the computing system 100.

The on-premises system 115 (also referred to as an on-premises infrastructure or environment) may be an example of a computing system in which a client organization owns, operates, and maintains its own physical hardware and/or software resources within its own data center(s) and facilities, instead of using cloud-based (e.g., off-site) resources. Thus, in the on-premises system 115, hardware, servers, networking equipment, and other infrastructure components may be physically located within the “premises” of the client organization, which may be protected by a firewall 140 (e.g., a network security device or software application that is configured to monitor, filter, and control incoming/outgoing network traffic). In some examples, users may remotely access or otherwise utilize compute resources of the on-premises system 115, for example, via a virtual private network (VPN).

In contrast, the cloud system 125 (also referred to as a cloud-based infrastructure or environment) may be an example of a system of compute resources (such as servers, databases, virtual machines, containers, and the like) that are hosted and managed by a third-party cloud service provider using third-party data center(s), which can be physically co-located or distributed across multiple geographic regions. The cloud system 125 may offer high scalability and a wide range of managed services, including (but not limited to) database management, analytics, machine learning (ML), artificial intelligence (AI), etc. Examples of cloud systems 125 include (AMAZON WEB SERVICES) AWS®, MICROSOFT AZURE®, GOOGLE CLOUD PLATFORM®, ALIBABA CLOUD®, ORACLE® CLOUD INFRASTRUCTURE (OCI), and the like.

The identity management system 120 may support one or more services, such as a single sign-on (SSO) service 155, a multi-factor authentication (MFA) service 160, an application programming interface (API) service 165, a directory management service 170, a provisioning service 175 for various on-premises applications 110 (e.g., applications 110 running on compute resources of the on-premises system 115) and/or cloud applications 110 (e.g., applications 110 running on compute resources of the cloud system 125), or a natural language user interface (UI) service 180, among other examples of services. The SSO service 155, the MFA service 160, the API service 165, the directory management service 170, the provisioning service 175 and/or the natural language UI service 180 may be individually or collectively provided (e.g., hosted) by one or more physical machines, virtual machines, physical servers, virtual (e.g., cloud) servers, data centers, or other compute resources managed by or otherwise accessible to the identity management system 120.

A user 185 may interact with the computing device 105 to communicate with one or more of the on-premises system 115, the identity management system 120, or the cloud system 125. For example, the user 185 may access one or more applications 110 by interacting with an interface 190 of the computing device 105. In some implementations, the user 185 may be prompted to provide some form of identification (such as a password, personal identification number (PIN), biometric information, or the like) before the interface 190 is presented to the user 185. In some implementations, the user 185 may be a developer, customer, employee, vendor, partner, or contractor of a client organization (such as a group, business, enterprise, non-profit, or startup that uses one or more services of the identity management system 120). The applications 110 may include one or more on-premises applications 110 (hosted by the on-premises system 115), mobile applications 110 (configured for mobile devices), and/or one or more cloud applications 110 (hosted by the cloud system 125).

The SSO service 155 of the identity management system 120 may allow the user 185 to access multiple applications 110 with one or more credentials. Once authenticated, the user 185 may access one or more of the applications 110 (for example, via the interface 190 of the computing device 105). That is, based on the identity management system 120 authenticating the identity of the user 185, the user 185 may obtain access to multiple applications 110, for example, without having to re-enter the credentials (or enter other credentials). The SSO service 155 may leverage one or more authentication protocols, such as Security Assertion Markup Language (SAML) or OpenID Connect (OIDC), among other examples of authentication protocols. In some examples, the user 185 may attempt to access an application 110 via a browser. In such examples, the browser may be redirected to the SSO service 155 of the identity management system 120, which may serve as the identity provider (IdP). For example, in some implementations, the browser (e.g., the user's request communicated via the browser) may be redirected by an access gateway 130 (e.g., a reverse proxy-based virtual application configured to secure web applications 110 that may not natively support SAML or OIDC).

In some examples, the access gateway 130 may support integrations with legacy applications 110 using hypertext transfer protocol (HTTP) headers and Kerberos tokens, which may offer universal resource locator (URL)-based authorization, among other functionalities. In some examples, such as in response to the user's request, the IdP may prompt the user 185 for one or more credentials (such as a password, PIN, biometric information, or the like) and the user 185 may provide the requested authentication credentials to the IdP. In some implementations, the IdP may leverage the MFA service 160 for added security. The IdP may verify the user's identity by comparing the credentials provided by the user 185 to credentials associated with the user's account. For example, one or more credentials associated with the user's account may be registered with the IdP (e.g., previously registered, or otherwise authorized for authentication of the user's identity via the IdP). The IdP may generate a security token (such as a SAML token or Oath 2.0 token) containing information associated with the identity and/or authentication status of the user 185 based on successful authentication of the user's identity.

The IdP may send the security token to the computing device 105 (e.g., the browser or application 110 running on the computing device 105). In some examples, the application 110 may be associated with a service provider (SP), which may host or manage the application 110. In such examples, the computing device 105 may forward the token to the SP. Accordingly, the SP may verify the authenticity of the token and determine whether the user 185 is authorized to access the requested applications 110. In some examples, such as examples in which the SP determines that the user 185 is authorized to access the requested application, the SP may grant the user 185 access to the requested applications 110, for example, without prompting the user 185 to enter credentials (e.g., without prompting the user to log-in). The SSO service 155 may promote improved user experience (e.g., by limiting the number of credentials the user 185 has to remember/enter), enhanced security (e.g., by leveraging secure authentication protocols and centralized security policies), and reduced credential fatigue, among other benefits.

The MFA service 160 of the identity management system 120 may enhance the security of the computing system 100 by prompting the user 185 to provide multiple authentication factors before granting the user 185 access to applications 110. These authentication factors may include one or more knowledge factors (e.g., something the user 185 knows, such as a password), one or more possession factors (e.g., something the user 185 is in possession of, such as a mobile app-generated code or a hardware token), or one or more inherence factors (e.g., something inherent to the user 185, such as a fingerprint or other biometric information). In some implementations, the MFA service 160 may be used in conjunction with the SSO service 155. For example, the user 185 may provide the requested login credentials to the identity management system 120 in accordance with an SSO flow and, in response, the identity management system 120 may prompt the user 185 to provide a second factor, such as a possession factor (e.g., a one-time passcode (OTP), a hardware token, a text message code, an email link/code). The user 185 may obtain access (e.g., be granted access by the identity management system 120) to the requested applications 110 based on successful verification of both the first authentication factor and the second authentication factor.

The API service 165 of the identity management system 120 can secure APIs by managing access tokens and API keys for various client organizations, which may enable (e.g., only enable) authorized applications (e.g., one or more of the applications 110) and authorized users (e.g., the user 185) to interact with a client organization's APIs. The API service 165 may enable client organizations to implement customizable login experiences that are consistent with their architecture, brand, and security configuration. The API service 165 may enable administrators to control user API access (e.g., whether the user 185 and/or one or more other users have access to one or more particular APIs). In some examples, the API service 165 may enable administrators to control API access for users via authorization policies, such as standards-based authorization policies that leverage OAuth 2.0. The API service 165 may additionally, or alternatively, implement role-based access control (RBAC) for applications 110. In some implementations, the API service 165 can be used to configure user lifecycle policies that automate API onboarding and off-boarding processes.

The directory management service 170 may enable the identity management system 120 to integrate with various identity sources of client organizations. In some implementations, the directory management service 170 may communicate with a directory service 145 of the on-premises system 115 via a software agent 150 installed on one or more computers, servers, and/or devices of the on-premises system 115. Additionally, or alternatively, the directory management service 170 may communicate with one or more other directory services, such as one or more cloud-based directory services. As described herein, a software agent 150 generally refers to a software program or component that operates on a system or device (such as a device of the on-premises system 115) to perform operations or collect data on behalf of another software application or system (such as the identity management system 120).

The provisioning service 175 of the identity management system 120 may support user provisioning and deprovisioning. For example, in response to an employee joining a client organization, the identity management system 120 may automatically create accounts for the employee and provide the employee with access to one or more resources via the accounts. Similarly, in response to the employee (or some other employee) leaving the client organization, the identity management system 120 may autonomously deprovision the employee's accounts and revoke the employee's access to the one or more resources (e.g., with little to no intervention from the client organization). The provisioning service 175 may maintain audit logs and records of user deprovisioning events, which may help the client organization demonstrate compliance and track user lifecycle changes. In some implementations, the provisioning service 175 may enable administrators to map user attributes and roles (e.g., permissions, privileges) between the identity management system 120 and connected applications 110, ensuring that user profiles are consistent across the identity management system 120, the on-premises system 115, and the cloud system 125.

The natural language UI service 180 of the identity management system 120 may support an interface for receiving natural language user queries from customers of the identity management system 120, such as from administrators of a client organization. The administrators may input queries through a user interface provided by the reports UI service. For example, the user interface may be a chat box or similar interface. The administrators may input queries to request information on one or more aspects of the identity management system 120, such as information related to system events, system configurations, errors occurring in the system, users associated with the client organization, resources associated with the client organization, system documentation, and the like. The query may be input in a natural language form. The natural language user query may be input to a machine learning model and the machine learning model may be trained to output or generate a query in a machine-readable language that is understandable by the identity management system 120. The model-generated machine-readable query, when executed by the identity management system 120, may cause information responsive to the user's request to be retrieved from data maintained by the identity management system. The retrieved information may be output for display in response to the user's request. In some cases, based on receiving a selection of one or more portions of the information output for display, the machine learning model may be employed to generate a natural language explanation of the selected one or more portions. In some cases, the natural language explanation may be a summarization of information associated with the selected one or more portions and retrieved from multiple data sources associated with the identity management system 120.

Although not depicted in the example of FIG. 1, a person skilled in the art would appreciate that the identity management system 120 may support or otherwise provide access to any number of additional or alternative services, applications 110, platforms, providers, or the like. In other words, the functionality of the identity management system 120 is not limited to the exemplary components and services mentioned in the preceding description of the computing system 100. The description herein is provided to enable a person skilled in the art to make or use the present disclosure. Various modifications to the present disclosure will be readily apparent to those skilled in the art, and the generic principles defined herein may be applied to other variations without departing from the scope of the present disclosure. Accordingly, the present disclosure is not limited to the examples and designs described herein, but is to be accorded the broadest scope consistent with the principles and novel features disclosed herein.

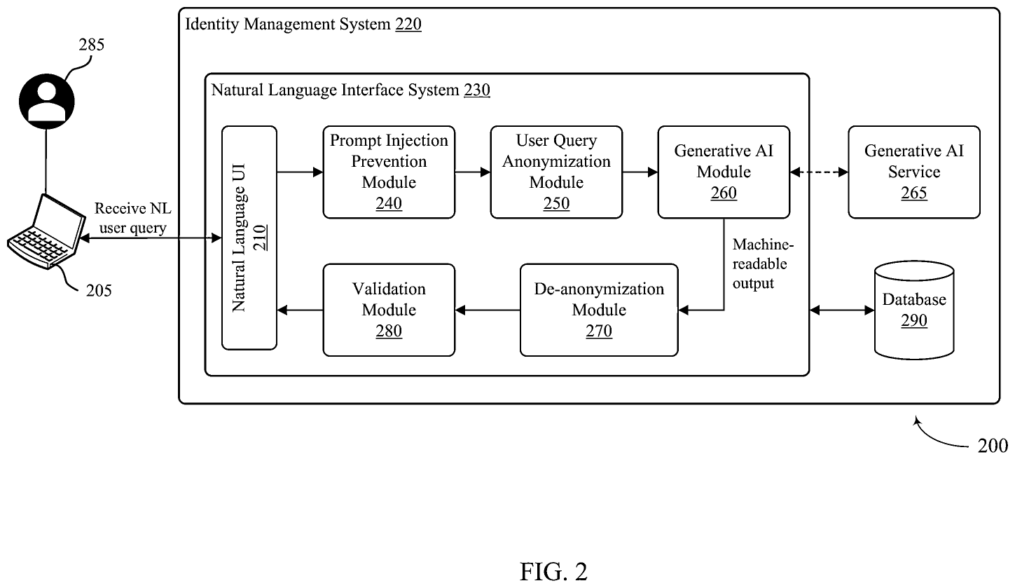

FIG. 2 shows an example of a system architecture 200 that supports a natural language interface for identity management data mining using generative AI in accordance with aspects of the present disclosure. The system architecture 200 may include a client device 205 and an identity management system 220. The client device 205 may be a device associated with a client organization and may be used, for example, by an administrator 285 of the client organization to access or interact with the identity management system 220. The identity management system 220 may comprise a natural language interface system 230, a generative AI service 265, and at least one database 290. The identity management system 220 may be an example of the identity management system 120 of FIG. 1. The natural language interface system 230 may comprise a natural language user interface (UI) 210, a prompt injection prevention module 240, a anonymization module 250, a generative AI module 260, a de-anonymization module 270, and a validation module 280. The natural language interface system 230 may be an example of the natural language UI service 180 of FIG. 1.

The client device 205 may access or interact with the natural language interface system 230 via the natural language UI 210. The natural language UI 210 may be a user interface that may receive a user input and display an output. For example, the natural language UI 210 may receive an input, such as a user query, in a natural language format. For example, the administrator 285 may input, via the client device 205, a natural language query (e.g., a statement or a question in a natural language, such as English, Japanese, Mandarin, Spanish, Arabic, or Russian, among other examples) into the natural language UI 210. As described herein, a natural language may include a language that developed naturally in a human community, for example, by a process of use, repetition, and change. The user query may be a request for information associated with the identity management system 220. As an illustrative example, the administrator 285 may input to the natural language UI 210, an English language statement such as “give me all the users that logged in today.” The user query may be transmitted to one or more modules of the natural language interface system 230. In some cases, the user query may initially be transmitted to the prompt injection prevention module 240. Responsive to the user query, a response may be generated and output by one or more modules of the natural language interface system 230 via the natural language UI 210. The natural language UI 210 may be an example of a chat box.

The prompt injection prevention module 240 may perform techniques that support the prevention of the insertion of a prompt or other language into the natural language user query. In some cases the prompt injection prevention module 240 may parse the natural language user query to determine whether the query includes language or prompts that may potentially be malicious or that may violate a constraint configured by the natural language interface system 230. For example, a user may include unintentional or malicious content in the natural language user query that may cause the natural language interface system 230 to inject potentially harmful information into the machine learning model and to output malicious output, such as a malicious model-generated machine-readable query. Such malicious or unintentional language or prompts may cause an output that may include sensitive information, information not associated with the client organization, information that the client organization may not have access to, or other information that violates a constraint configured by the natural language interface system 230, thus creating security vulnerabilities for the identity management system 220. In some cases, data identifying potential malicious language or prompts or constraints or rules for identifying such language/prompts may be maintained in the database 290 and the prompt injection prevention module 240 may access the data in the database 290 to analyze the user query to identify any language or prompts that may potentially be malicious or that may violate a constraint. In some cases, the prompt injection prevention module 240 may modify the user query to remove the identified language from the user query. In some cases, the prompt injection prevention module 240 may reject the user query when such language is identified. The prompt injection prevention module 240 may output a notification, such as via the natural language UI 210, indicating the removal of the identified language from the user query or the rejection of the user query. Such techniques may prevent or reduce a likelihood of bad or malicious data being injected into the machine learning model (which may degrade the performance and accuracy of subsequent outputs of the machine learning model) and may also prevent or reduce the likelihood of a malicious model-generated machine-learning query being generated by the machine learning model and executed by the natural language interface system 230.

The anonymization module 250 may perform techniques that support anonymizing the user query. For instance, the anonymization module 250 may parse the natural language user query to identify personally-identifiable or sensitive information (such as user names, login credentials, account numbers, social security numbers, financial information, or the like) included in the user query. When identified, the anonymization module 250 may modify the user query to replace the personally-identifiable information with a placeholder value. By way of example, if a user name “Jack Smith” is identified in the user query, the anonymization module 250 may modify the user query to replace “Jack Smith” with the placeholder “$user_name_1$.” The anonymization module 250 may further cache, or otherwise persist or store, the identified personally-identifiable information. Such techniques may prevent or reduce a likelihood of having personal or sensitive information injected into the machine learning model. In some cases, the anonymization module 250 may perform the described anonymization techniques prior to the prompt injection prevention module 240 performing the described prompt injection prevention techniques.

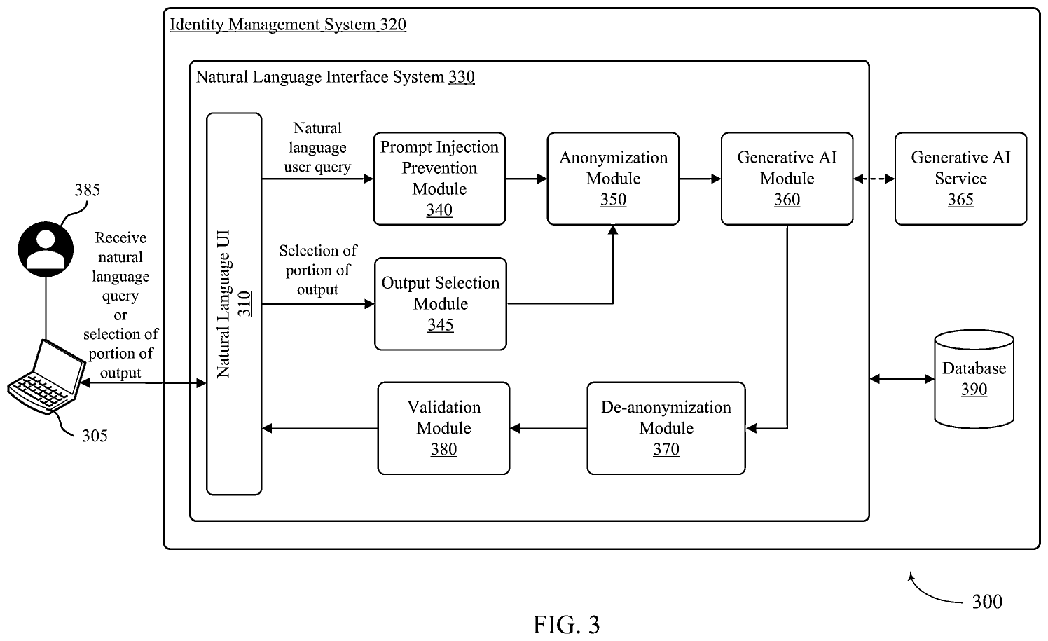

The generative AI module 260 may support communication with a generative AI service, such as the generative AI service 265 or one or more other types of systems that support foundational and fine-tuned machine learning models (e.g., pre-trained machine learning models), such as large language models (LLMs). For example, the generative AI service 265 may be an example of, or may employ, one or more machine learning models trained to translate a natural language user query into a machine-readable query. For instance, the generative AI service 265 may be trained to interpret a natural language query from a user and construct a machine-readable query, that when executed, may be responsive to the user's query. The one or more machine learning models employed by the generative AI service 265 may include different machine learning models to generate responses for different kinds of user queries or different types of selected output (discussed further with respect to FIG. 3), to support different client organizations, or the like.

The generative AI module 260 may receive the pre-processed user query (the user query having been pre-processed to remove malicious language and prompts and to replace personally-identifiable information with placeholder data). In some cases, the generative AI module 260 may identify one or more prompts to embed within the pre-processed user query (in some implementations, the pre-processed user query may be embedded in the one or more prompts). The generative AI module 260 may select the one or more prompts from a prompt store. The prompt store may be maintained in the database 290. The generative AI module 260 may select the one or more prompts based on the user query, such as based on a determined intent of the user query. For instance, the generative AI module 260 may analyze the user query to determine an intent, context, or meaning associated with the user query. In some cases, the intent may be determined based on previous user queries received from the administrator 285 within a threshold period of time. For instance, based on one or more immediately previous user queries. For example, queries received during the same active session, queries received during the same day, or the like. In some cases, the intent may be determined based on analyzing a history of user queries from the administrator 285 or from other administrators having input similar user queries in the past. The generative AI module 260 may select the one or more prompts based on the intent, context, or meaning associated with the user query. In some cases, at least one of the selected prompts, when embedded with the user query, may cause the generative AI service 265 to generate the model-generated machine-readable query. In some cases, at least one of the selected prompts, when embedded with the user query, may cause the generative AI service 265 to query one or more logs, database tables, or files associated with the identity management system 220. For example, the selected prompt may cause one or more of system logs, security logs, configuration logs, analytics logs, threat logs, management logs, machine access logs, browser activity logs, extended detection and response (XDR) logs, error logs, mobile device management (MDM) logs, database tables, or files to be used for generating the machine-readable query. In some cases, generative AI module 260 may employ the anonymization module 250 to anonymize information in the one or more prompts before being sent to the generative AI service 265.

The generative AI module 260 may employ the generative AI service 265 to generate an output for the user query. For instance, the generative AI service 265 may translate the natural language user query into a machine-readable query that is generated to retrieve data from one or more logs, databases, or files that is responsive to the user's query. The model-generated machine-readable query may be generated in a machine-readable language that is associated with and understandable by the identity management system. For example, the machine-readable language may include a reporting query language (RQL), a database query language, or an expression language, such as Structured Query Language (SQL), OKTA Expression Language (EL), System for Cross-domain Identity Management (SCIM) filter expression language, regular expression language, or the like. The generative AI module 260 may output the model-generated machine-readable query to the de-anonymization module 270.

Although the generative AI service 265 is illustrated in the example of FIG. 2 as being external to the natural language interface system 230, the generative AI service 265 may, in some implementations, be internal to the natural language interface system 230. Further, in some implementations, the generative AI module 260 and the generative AI service 265 may be implemented as a single module.

The de-anonymization module 270 may receive the model-generated machine-readable query from the generative AI module 260 and may de-anonymize the model-generated machine-readable query. The de-anonymization module 270 may de-anonymize the model-generated machine-readable query by replacing any placeholder data embedded in the machine-readable query with cached or stored personally-identifiable data associated with the placeholder and that was previously removed from the natural language user query by the anonymization module 250 before passing the user query to the generative AI module 260. Accordingly, the de-anonymization module 270 may determine whether the model-generated machine-readable query includes any placeholders embedded therein. In the case that any placeholders are identified, the de-anonymization module 270 may retrieve from cache, or other storage, the associated personally-identifiable data and modify the model-generated machine-readable query to replace the placeholder with the corresponding personally-identifiable data. Returning to the previous example, if the user name “Jack Smith” was identified in the user query and replaced with the placeholder “$user_name_1$,” the de-anonymization module 270 may de-anonymize the model-generated machine-readable query by modifying the model-generated machine-readable query to replace the placeholder “$user_name_1” with the user name “Jack Smith.” The de-anonymization module 270 may output the de-anonymized model-generated machine-readable query to the validation module 280.

The validation module 280 may receive the de-anonymized model-generated machine-readable query from the de-anonymization module 270 and may validate the query to ensure that the generative AI module 260 generated a query that is capable of being executed by the natural language interface system 230. For instance, the validation module 280 may parse the model-generated machine-readable query to validate that the syntax of the query is accurate, that data sources referred to are accurate, and the like. The validation module 280 may compare the model-generated machine-readable query to a known syntax of the machine-readable language used to generate the query. The validation module 280 may further compare the model-generated machine-readable query to a schema associated with a database or other data source (files, directories, file structures, networks, etc.) associated with the identity management system 220. The validation module 280 may modify the model-generated machine-readable query to correct any detected errors. The post-processed model-generated machine-readable query (the model-generated machine-readable query having been post-processed to de-anonymize and validate the model-generated machine-readable query) may be executed, which may cause information responsive to the natural language user query to be retrieved. For instance, the requested configuration data or system event data may be retrieved and may be output at the natural language UI 210. In some cases, the validation module 280 may perform the described validation techniques prior to the de-anonymization module 270 performing the described de-anonymization techniques.

In some cases, the output may include a one or more records, data elements, images, graphs, video, links, or the like, or a combination thereof.

In some cases, the generative AI module 260 may be generate the machine-readable query in a first machine-readable language that may be suitable for output to the administrator 285, such as so the administrator 285 may review and inspect the model-generated machine-readable query before or after executing the machine-readable query to determine if the machine-readable query is responsive to the user query or to customize the query further by making revisions to the query. As an example, the first machine-readable language may be RQL. The model-generated machine-readable query in the first machine-readable language may be output to the natural language UI 210. For instance, the administrator 285 may make a selection, via the natural language UI, to output the model-generated machine-readable query. The administrator 285 may then be enabled to view or edit the model-generated machine-readable query via the natural language UI. Based on receiving an indication of a modification to the model-generated machine-readable query, the natural language interface system 230 may cause the modified model-generated machine-readable query to be translated from the first machine-readable language to a second machine-readable language. For instance, the second machine-readable language may be a language that is used by one or more systems, databases, etc. associated with the identity management system 220. As an example, the second machine-readable language may be SQL. Translating the model-generated machine-readable query from the first machine-readable language to the second machine-readable may include compiling the modified model-generated machine-readable query in the first machine-readable language to generate the modified model-generated machine-readable query in the second machine-readable language. After the model-generated machine-readable query is translated to the second machine-readable language, the machine-readable query may be executed, causing information responsive to the natural language query to be retrieved and output via the natural language UI 210.

In some cases, the administrator 285 may input a second user query within a threshold amount of time from output of the information, and information associated with the second user query may be passed, as feedback, to an AI training module to be used to further train or adjust one or more weights associated with the generative AI module 360 or generative AI service 365 or to update training data.

FIG. 3 shows an example of a system architecture 300 that supports a natural language interface for identity management data mining using generative AI in accordance with aspects of the present disclosure. The system architecture 300 may include a client device 305 and an identity management system 320. The identity management system 320 may comprise a natural language interface system 330, a generative AI service 365, and at least one database 390. The natural language interface system 330 may comprise a natural language user interface (UI) 310, a prompt injection prevention module 340, an output selection module 345, a anonymization module 350, a generative AI module 360, a de-anonymization module 370, and a validation module 380. The identity management system 320 may be an example of the identity management system 120 of FIG. 1. The natural language interface system 330 may be an example of the natural language UI service 180 of FIG. 1. The identity management system 320 and its components may be similar to the identity management system 220 of FIG. 2 and its corresponding components, except that the natural language interface system 330 may additionally include an output selection module 345 not shown in the identity management system 220.

The client device 305 may perform in a manner similar to that described with respect to client device 205 of FIG. 2. For instance, the client device 305 may access or interact with the natural language interface system 330 via the natural language UI 310, which may be similar to the natural language UI 210. In addition to receiving a natural language user query via the client device 305, the natural language UI 210 may additionally receive a selection of at least of portion of the information output at the natural language UI 310. For instance, after the user inputs a natural language user query, the user query may be passed to the prompt injection prevention module 340, which may function in a manner similar to the prompt injection prevention module 240 of FIG. 2 to remove any malicious prompts or language, the anonymization module 350 may subsequently remove any personally-identifiable information in a matter similar to that described for the anonymization module 250 of FIG. 2. Thereafter, the generative AI module 360 and/or the generative AI service 365 may generate a machine-readable query such as described with the generative AI module 260 and the generative AI service 265 of FIG. 2. The model-generated machine-readable query may be de-anonymized by the de-anonymization module 370 to add the personally-identifiable information back to the model-generated machine-readable query as described with the de-anonymization module 270 of FIG. 2. The validation module 380 may then validate the model-generated machine-readable query such as described with the validation module 280 of FIG. 2 to ensure that the query is capable of being properly executed. Once executed, information responsive to the user query may be retrieved and the retrieved information may be output at the natural language UI 310. The output may include one or more records, data elements, images, graphs, video, links, or the like. At least a portion of the information output may be selected (such as by being clicked on by the user) to receive further information about the selected portion. For instance, if a plurality of records are output, the administrator 385 may select, via the natural language UI 310, one or more of the records to receive further information about, such as an explanation or a summarization information associated with the selected portions. In such cases, information identifying the selected portions may be passed to output selection module 345.

The output selection module 345 may determine a context of the selected portion. For instance, the output selection module 345 may determine what content was selected or what the meaning of the selected content is. In some cases, the output selection module 345 may select from a prompt store, such as maintained in the database 390, one or more prompts to embed with the selected portion. The one or more prompts may be selected based on the selected portion and/or based on the determined context for the selected portion. The selected portion may be embedded in the selected prompts (or the selected prompts may be embedded in the selected portion) and the selected portion and selected prompts may be passed to the anonymization module 350.

The anonymization module 350 may anonymize the selected portion. For instance, the anonymization module 350 may parse the selected portion to identify personally-identifiable or sensitive information (such as user names, login credentials, account numbers, social security numbers, financial information, or the like) included in the selected portion. When identified, the anonymization module 350 may modify the selected portion to replace the personally-identifiable information with a placeholder value. By way of example, if account number “A-76594” is identified in the selected portion, the anonymization module 350 may modify the user query to replace “A-76594” with the placeholder “$account_number_1$.” The anonymization module 350 may further cache, or otherwise persist or store, the identified personally-identifiable information. Such techniques may prevent or reduce a likelihood of having personal or sensitive information injected into the machine learning model. The pre-processed selected portion (the selected portion having the context prompts embedded and the personally-identifiable information removed) may be passed to the generative AI module 360.

The generative AI module 360 may support communication with an generative AI service, such as the generative AI service 365. The generative AI service 365 may be an example of, or may employ, a machine learning model. In addition to being trained to translate a natural language user query into a machine-readable query as described with respect to the generative AI service 265 of FIG. 2, the generative AI service 365 may additionally be trained to understand or identify the content of a selected portion of output and identify further information associated with the selected portion. In some cases, the generative AI service 365 may be trained to output a summarization in natural language form of the further information.

The generative AI module 360 may receive the pre-processed selected portion. In some cases, the generative AI module 360 may identify one or more additional prompts to embed within the pre-processed selected portion (in some implementations, the pre-processed selected portion may be embedded in the one or more prompts). The generative AI module 360 may select the one or more additional prompts from the prompt store maintained in the database 390. The generative AI module 360 may select the one or more prompts based on the selected portion, such as based on a determined intent of the selected portion. In some cases, the intent may be determined based on the context determined by the output selection module 345. In some cases, the intent may be determined based on previous selections of portions of the output received from the administrator 385 within a threshold period of time. For instance, based on one or more immediately previous selections. For example, selections received during the same active session, during the same day, or the like. In some cases, the intent may be determined based on analyzing a history of selections from the administrator 385 or from other administrators having made similar selections in the past. In some cases, at least one of the selected prompts, when embedded with the selected portion, may cause the generative AI service 365 to generate a natural language response (i.e., a human-readable response rather than a machine-readable query as in the case when the generative AI service 365 receives the natural user query). The at least one selected prompt may further cause the generative AI service 365 to provide a summarization of information associated with the selected portion to provide further information about the selected portion in an easy to read natural language form. For instance, in some cases, the generative AI service 365 may extract and distill or summarize key facets of a given data point or data set associated with the selected portion. In some cases, the generative AI service 365 may extract, aggregate, and summarize key data sets associated with the selected portion. By performing such summarization, the natural language interface system 330 may avoid outputting large quantities of information from different sources for the administrator 385 to sort through, and instead, may be able to distill or summarize all of the information and provide the summarized information to the administrator 385 in way that is easy to consume and understand.

The generative AI module 360 may employ the generative AI service 365 to generate an output based on the selected portion embedded with the one or more prompts. For instance, the generative AI service 365 may identify and summarize information that provides further details, supplemental information, or an explanation of the selected portion. The information may be output in a natural language form.

Although the generative AI service 365 is illustrated in the example of FIG. 3 as being external to the natural language interface system 330, the generative AI service 365 may, in some implementations, be internal to the natural language interface system 330. Further, in some implementations, the generative AI module 360 and the generative AI service 365 may be implemented as a single module.

The de-anonymization module 370 may receive the summary of the further information associated with the selected potions from the generative AI module 360 and may de-anonymize the model-generated summary. The de-anonymization module 370 may de-anonymize the model-generated summary by replacing any placeholder data with cached or stored personally-identifiable data associated with the placeholder and that was previously removed from the selected portion by the anonymization module 350 before passing the selected portion to the generative AI module 360. Accordingly, the de-anonymization module 370 may determine whether the model-generated summary includes any placeholders embedded therein. In the case that any placeholders are identified, the de-anonymization module 370 may retrieve from cache, or other storage, the associated personally-identifiable data and modify the model-generated summary to replace the placeholder with the corresponding personally-identifiable data. Returning to the previous example, if the account number “A-76594” was identified in the selected portions and replaced with the placeholder “$account_number_1$,” the de-anonymization module 370 may de-anonymize the model-generated summary by modifying the model-generated summary to replace the placeholder “$account_number_1$” with the account number “A-76594.” The de-anonymization module 370 may output the de-anonymized model-generated summary to the validation module 380.

The validation module 380 may receive the de-anonymized model-generated summary from the de-anonymization module 370 and may validate the summary to correct any typographical, syntactical, grammatical, semantical, or other mistakes in the model-generated summary. The validated summary may be output to the natural language UI 310.

In some cases, subsequent selections or user queries by the administrator may be used to be fed back to an AI training module to train or adjust one or more weights associated with the generative AI module 360 or generative AI service 365 or to update training data.

In some cases, the natural language interface system 330 may further be used to create custom, ad-hoc reports by iteratively asking the administrator 385 filtering questions in response to an initial natural language user query.

In some cases, in addition to outputting information responsive to the natural language user query or selection of an output resulting from the user query, the natural language interface system 330 may further cause an action to take place in the identity management system 320. For instance, a configuration to be created, modified, or removed; an authorization policy to be generated for an application, access privileges for a user to be adjusted, one or more system settings to be adjusted, or the like.

Accordingly, the natural language interface system 330 may be used by the administrator 385 for the purpose of discovery, such as to discover information about a system event or configuration; to obtain knowledge about the identity management system 320, such as information related to how a certain aspect to the identity management system 320 functions or how to perform a particular task in the identity management system 320; or to cause an action to be performed, such as adjusting one or more configuration aspects in the identity management system 320.

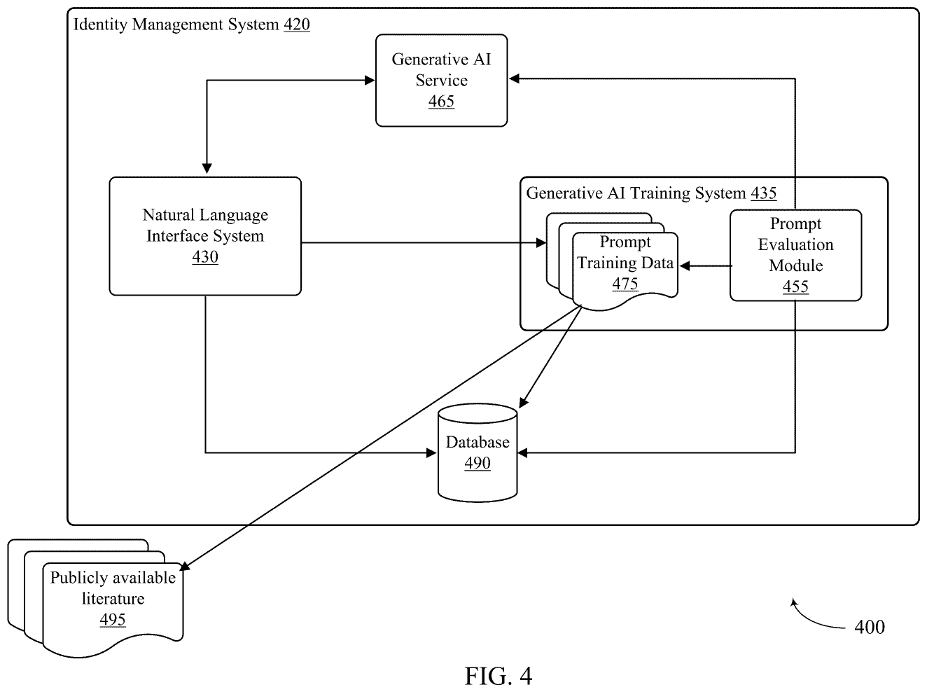

FIG. 4 shows an example of a system architecture 400 that supports training a generative AI system of an identity management system 420 to support a natural language interface for identity management data mining in accordance with aspects of the present disclosure. The identity management system 420 may be an example of the identity management system 120 of FIG. 1. The identity management system 420 may comprise a natural language interface system 430, a generative AI training system 435, a generative AI service 465, and at least one database 490. The natural language interface system 430 may be an example of the natural language UI service 180 of FIG. 1, the natural language interface system 230 of FIG. 2, or the natural language interface system 330 of FIG. 3. The generative AI training system 435 may include a prompt evaluation module 455 and prompt training data 475. The database 490 may be an example of the database 290 or database 390 of FIGS. 2 and 3. The database 490 may be one or more databases that include identity management data related to client organizations, users of the client organizations, system configurations, system events, resources, and the like. The database 490 may additionally include a prompt store or database of prompts for embedding with data input into the generative AI service 465.

The natural language interface system 430 may employ the generative AI service 465 to output a machine-readable query responsive to a natural language user query for information associated with the identity management system 420, as described with respect to FIGS. 2 and 3. The natural language interface system 430 may additionally interact with the generative AI training system 435 to provide feedback to the generative AI training system 435 to be used to further train or adjust one or more weights associated with the machine learning model or to update training data such as prompt training data 475.

The generative AI training system 435 may pre-configure or pre-train the generative AI service 465. In some cases, the generative AI training system 435 may additionally re-train the generative AI service 465. The generative AI training system 435 may pre-configure the generative AI service 465 to study data in the database 490, such as identity management related data, and to generate rules for natural language processing. The pre-configuration may be performed based on using an initial sample of natural language questions to abstract the rules for the generative AI service 465. This may assist in improving the ability of the model to generate an accurate machine-readable query. Additionally, during the life-cycle of processing in the identity management system 420, the generative AI training system 435 may capture actual client organization and user interactions to further improve the rules for natural language processing.

Next, the generative AI training system 435 may process and translate the business rules into a public data schema and natural language processing rules to pre-configure or pre-train the generative AI service 465 for generating machine-readable queries from natural language queries. To accomplish this, the generative AI training system 435 may convert a data schema of an identity management system database, such as database 490, to a public data schema by enforcing one or more data privacy and security policies. The generative AI training system 435 may feed the public data schema to the generative AI service 465 with rules to pre-configure the generative AI service 465. The generative AI training system 435 may store the mapping relationship between identity management system data schema and public data schema. In some cases, the generative AI training system 435 may re-configure the generative AI service 465 with polished or updated rules. The generative AI training system 435 may then publish the public data schema to the client organizations.

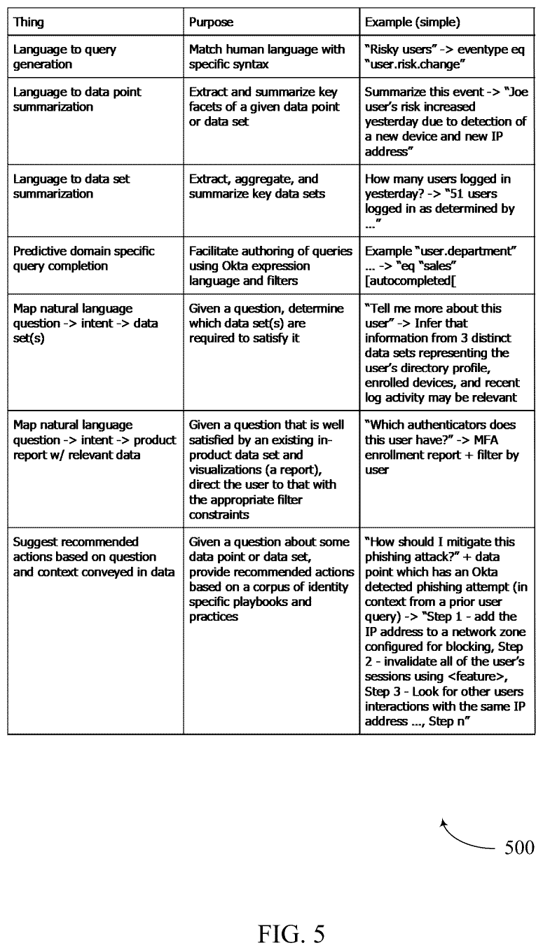

FIG. 5 shows an example of capabilities 500 of a generative AI system that supports a natural language interface for identity management data mining in accordance with aspects of the present disclosure. Capabilities 500 may describe example capabilities of a generative AI system used by an identity management system, such as identity management system 120, identity management system 220, identity management system 320, or the identity management system 420 illustrated in FIGS. 2, 3, and 4. For example, the capabilities may refer to the capabilities of the generative AI module 260, generative AI service 265, generative AI module 360, the generative AI service 365, generative AI module 460, or generative AI service 465 illustrated in FIGS. 2, 3, and 4.

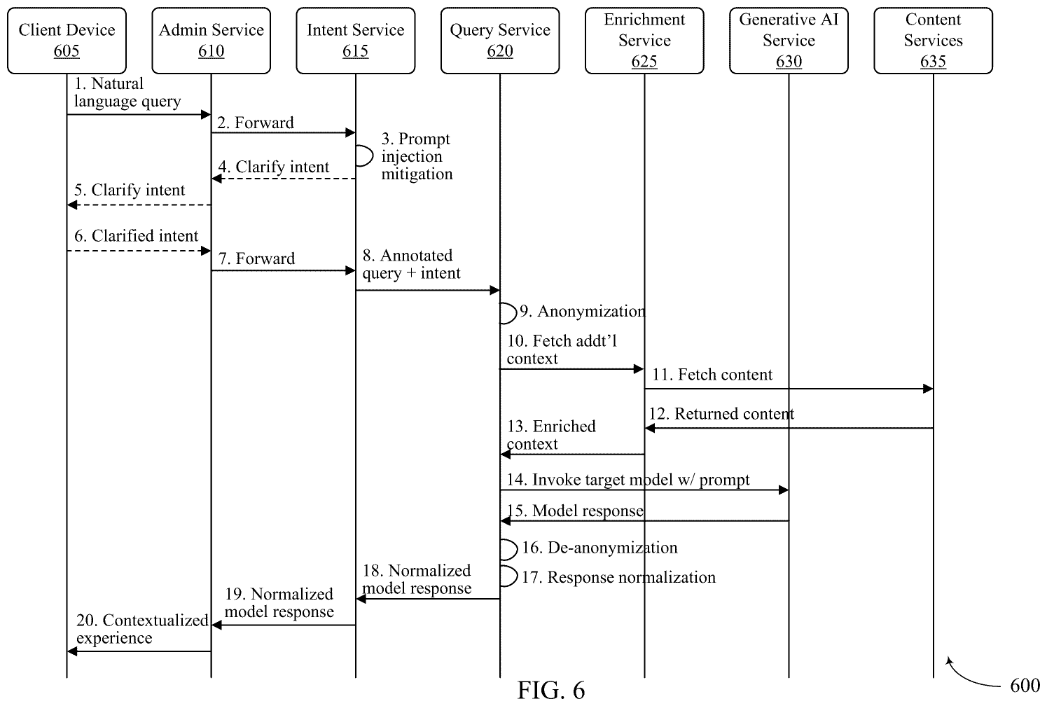

FIG. 6 shows an example of a protocol 600 that supports a natural language interface for identity data management mining using generative AI in accordance with aspects of the present disclosure. The protocol 600 may be a general protocol for a natural language interface system of an identity management system, such as natural language interface system 230, natural language interface system 330, or natural language interface system 430 of FIGS. 2, 3, and 4.

At step 1 of the protocol 600, a client device 605 may send a natural language user query to an administrative service 610. Such as a user query for information associated with the identity management system. The client device 605 may be an example of the client device 205, client device 305, or client device 405 of FIGS. 2, 3, and 4. At step 2, the administrative service 610 may receive the natural language query and forward the query to an intent service to determine an intent of the natural language user query.

At step 3, the intent service 615 may determine the intent of the user query and perform prompt injection mitigation, such as to ensure malicious or harmful language or prompts were not injected in the user query. In some cases, the intent service 615 may modify the user query to remove the malicious language or prompts, or may reject the user query. At step 4, in some cases, the intent service 615 may request that the administrative service 610 receive further information to clarify the intent of the user query. At step 5, the administrative service 610 may forward the request to the client device 605 requesting further information to clarify the intent of the user query.

At step 6, the client device 605 may receive further information from the user, such as by prompting the user with one or more additional questions to clarify the user's intent with respect to the initial user query. The client device 605 may forward the user query with the clarified intent to the administrative service 610. At step 7, the administrative service 610 may forward the user query with the clarified intent to the intent service 615. At step 8, the intent service 615 may forward the user query annotated with the intent to the query service 620.

At step 9, the query service 620 may anonymize the user query by removing personally-identifiable information or other sensitive information.

At step 10, the query service 620, may send a request to the enrichment service 625 for additional context for the user query. At step 11, the enrichment service 625 may fetch, from one or more content services 635, information to determine additional context for the user query. For instance, the one or more content services 635 may be queried for content associated with the user query. At step 12, the one or more content services 635 may return the content to the enrichment services 625. At step 13, the enrichment services 625 may use the returned content to determine additional or enriched context associated with the user query, and may forward the enriched context to the query service 620.

At step 14, the query service 620 may invoke a machine learning model provided by the generative AI service 630. The query service may further provide one or more prompts to the generative AI service 630. The one or more prompts may be embedded in the natural language user query or the natural language user query may be embedded in the one or more prompts. The one or more prompts may be determined based on the determined context associated with the user query. The generative AI service 630 may translate the natural language user query based on the user query and the one or more prompts and may generate a machine-readable query responsive to the user query. The generative AI service 630 may be an example of generative AI module 260, generative AI service 265, generative AI module 360, generative AI service 365, generative AI module 460, or generative AI service 465 illustrated in FIGS. 2, 3, and 4.

At step 15, the generative AI service 630 may output the model-generated response to the query service 620. For example, the generative AI service 630 may output the model-generated machine-readable query to the query service 620.

At step 16, the query service 620 may de-anonymize the model-generated response by adding back any personally-identifiable or sensitive information that was removed at step 9.

At step 17, the query service 620 may further normalize the model-generated response by validating that the machine-generated query meets any constraints associated with the identity management system, that the machine-generated query is syntactically accurate, and that the machine-generated query is capable of being executed. The machine-generated query may be executed to generate the normalized response. The query service 620 may further perform additional or different steps to normalize the response. Steps 9 through 17 may be iterated.

At step 18, the query service 620 may forward the normalized response to the intent service 615, and at step 19, the intent service 615 may forward the normalized response to the administrative service 610. At step 20, the administrative service 610 may forward the normalized response to the client device 605 for a contextualized user experience.

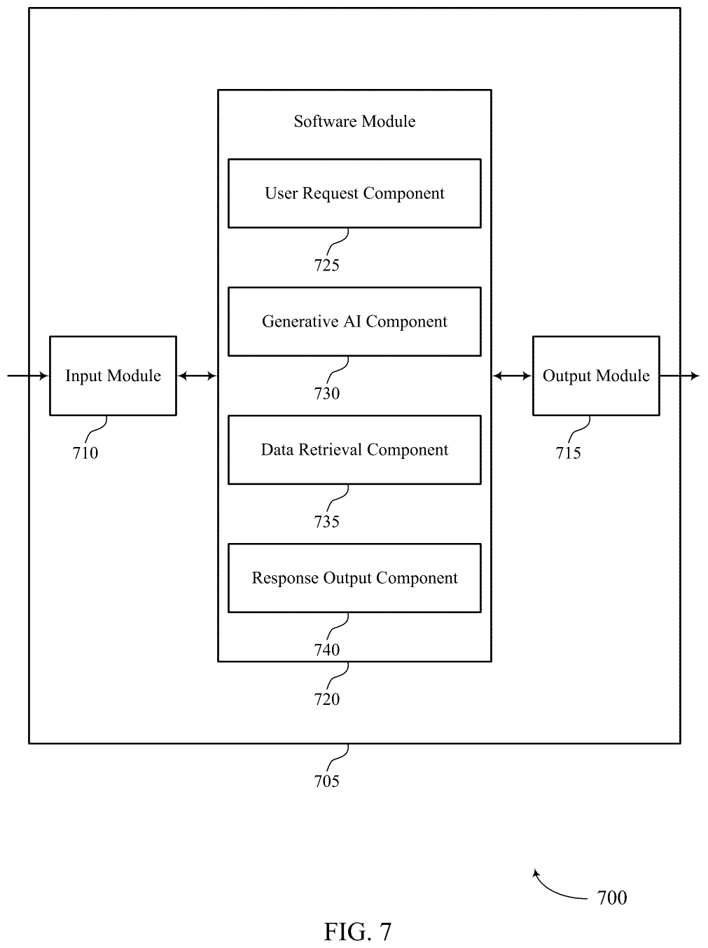

FIG. 7 shows a block diagram 700 of a device 705 that supports a natural language interface for identity management data mining using generative AI in accordance with aspects of the present disclosure. The device 705 may include an input module 710, an output module 715, and a software module 720. The device 705, or one of more components of the device 705 (e.g., the input module 710, the output module 715, and the software module 720), may include at least one processor, which may be coupled with at least one memory, to support the described techniques. Each of these components may be in communication with one another (e.g., via one or more buses).

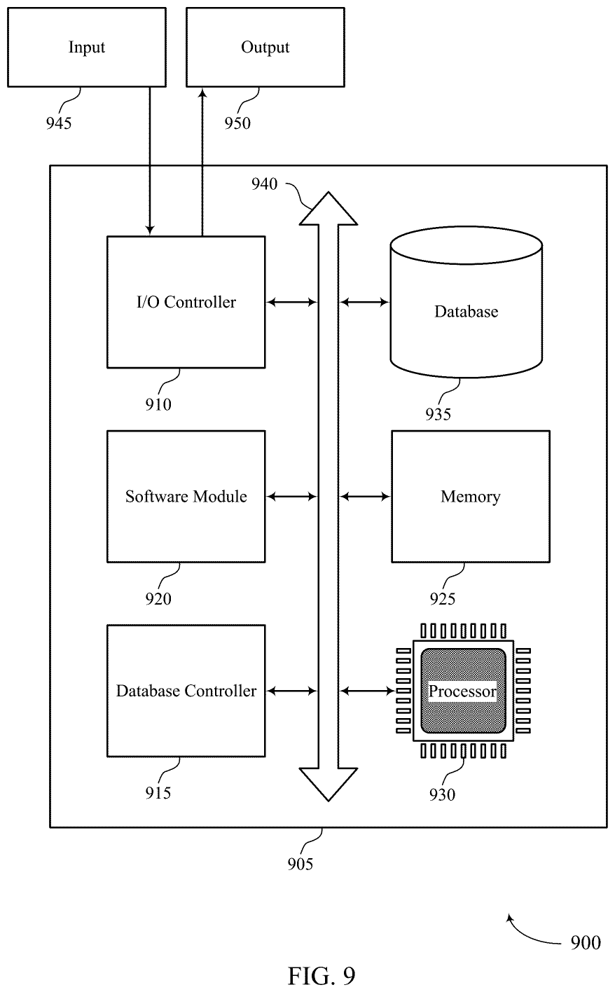

The input module 710 may manage input signals for the device 705. For example, the input module 710 may identify input signals based on an interaction with a modem, a keyboard, a mouse, a touchscreen, or a similar device. These input signals may be associated with user input or processing at other components or devices. In some cases, the input module 710 may utilize an operating system such as iOS®, ANDROID®, MS-DOS®, MS-WINDOWS®, OS/2®, UNIX®, LINUX®, or another known operating system to handle input signals. The input module 710 may send aspects of these input signals to other components of the device 705 for processing. For example, the input module 710 may transmit input signals to the software module 720 to support natural language interface for identity data mining using generative AI. In some cases, the input module 710 may be a component of an input/output (I/O) controller 910 as described with reference to FIG. 9.

The output module 715 may manage output signals for the device 705. For example, the output module 715 may receive signals from other components of the device 705, such as the software module 720, and may transmit these signals to other components or devices. In some examples, the output module 715 may transmit output signals for display in a user interface, for storage in a database or data store, for further processing at a server or server cluster, or for any other processes at any number of devices or systems. In some cases, the output module 715 may be a component of an I/O controller 910 as described with reference to FIG. 9.

For example, the software module 720 may include a user request component 725, a generative AI component 730, a data retrieval component 735, a response output component 740, or any combination thereof. In some examples, the software module 720, or various components thereof, may be configured to perform various operations (e.g., receiving, monitoring, transmitting) using or otherwise in cooperation with the input module 710, the output module 715, or both. For example, the software module 720 may receive information from the input module 710, send information to the output module 715, or be integrated in combination with the input module 710, the output module 715, or both to receive information, transmit information, or perform various other operations as described herein.

The user request component 725 may be configured to support receiving, from a client device associated with a client organization, a natural language user query, where the natural language user query includes a request for information related to a configuration data or a system event occurring in the identity management system and associated with the client organization. The generative AI component 730 may be configured to support generating, based on the natural language user query and using a machine learning model, a model-generated machine-readable query, where the model-generated machine-readable query is generated in a machine-readable language associated with the identity management system. The data retrieval component 735 may be configured to support retrieving, based on executing the model-generated machine-readable query, information responsive to the natural language user query. The response output component 740 may be configured to support outputting the information responsive to the natural language user query.

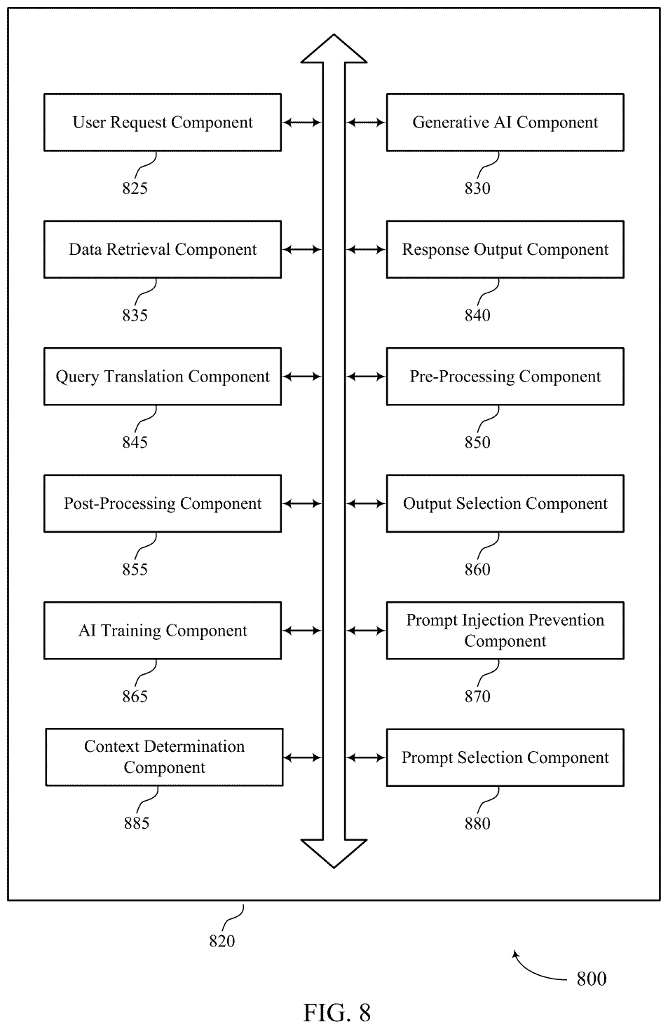

FIG. 8 shows a block diagram 800 of a software module 820 that supports a natural language interface for identity management data mining using generative AI in accordance with aspects of the present disclosure. The software module 820 may be an example of aspects of a software module or a software module 720, or both, as described herein. The software module 820, or various components thereof, may be an example of means for performing various aspects of natural language interface for identity data mining using generative AI as described herein. For example, the software module 820 may include a user request component 825, a generative AI component 830, a data retrieval component 835, a response output component 840, a query translation component 845, a pre-processing component 850, a post-processing component 855, a output selection component 860, an AI training component 865, a prompt injection prevention component 870, a prompt selection component 880, a context determination component 885, or any combination thereof. Each of these components, or components of subcomponents thereof (e.g., one or more processors, one or more memories), may communicate, directly or indirectly, with one another (e.g., via one or more buses).

The user request component 825 may be configured to support receiving, from a client device associated with a client organization, a natural language user query, where the natural language user query includes a request for information related to configuration data or a system event occurring in the identity management system and associated with the client organization. The generative AI component 830 may be configured to support generating, based on the natural language user query and using a machine learning model, a model-generated machine-readable query, where the model-generated machine-readable query is generated in a machine-readable language associated with the identity management system. The data retrieval component 835 may be configured to support retrieving, based on executing the model-generated machine-readable query, information responsive to the natural language user query. The response output component 840 may be configured to support outputting the information responsive to the natural language user query.

In some examples, the machine-readable language includes a reporting query language (RQL), a database query language, or an expression language.

In some examples, the database query language includes Structured Query Language (SQL).

In some examples, the expression language includes OKTA Expression Language (EL), System for Cross-domain Identity Management (SCIM) filter expression, regular expression.

In some examples, the model-generated machine-readable query is generated in a first machine-readable language, and the response output component 840 may be configured to support outputting the model-generated machine-readable query in the first machine-readable language. In some examples, the model-generated machine-readable query is generated in a first machine-readable language, and the user request component 825 may be configured to support receiving an indication of a modification to the model-generated machine-readable query. In some examples, the model-generated machine-readable query is generated in a first machine-readable language, and the query translation component 845 may be configured to support translating the modified model-generated machine-readable query from the first machine-readable language to a second machine-readable language. In some examples, the model-generated machine-readable query is generated in a first machine-readable language, and the data retrieval component 835 may be configured to support where retrieving the information responsive to the natural language user query includes retrieving, based on executing the modified model-generated machine-readable query in the second machine-readable language, the information responsive to the natural language user query.

In some examples, outputting the model-generated machine-readable query in the first machine-readable language is in response to receiving an indication of a user selection to view the model-generated machine-readable query.

In some examples, the translating includes compiling the modified model-generated machine-readable query in the first machine-readable language to generate the modified model-generated machine-readable query in the second machine-readable language.

In some examples, the first machine-readable language includes RQL.

In some examples, the second machine-readable language includes SQL.

In some examples, the model-generated machine-readable query, when executed, retrieves the information from one or more system logs, security logs, configuration logs, analytics logs, threat logs, management logs, machine access logs, browser activity logs, extended detection and response (XDR) logs, error logs, mobile device management (MDM) logs, database tables, or files.

In some examples, the retrieved information includes the information related to the configuration data or the system event occurring in the identity management system.

In some examples, the model-generated machine-readable query, when executed, retrieves the information from one or more report tables.

In some examples, the one or more report tables include the information related to the configuration data or the system event occurring in the identity management system.

In some examples, the pre-processing component 850 may be configured to support prior to generating the model-generated machine-readable query, pre-processing the natural language user query. In some examples, the generative AI component 830 may be configured to support where generating the model-generated machine-readable query includes generating, based on the pre-processed natural language user query and using the machine learning model, the model-generated machine-readable query.

In some examples, to support pre-processing, the prompt injection prevention component 870 may be configured to support parsing the natural language user query to determine whether the natural language user query includes language that may be potentially malicious, or language that violates a constraint configured by the identity management system.

In some examples, the prompt injection prevention component 870 may be configured to support removing the determined language.

In some examples, the prompt injection prevention component 870 may be configured to support outputting a notification indicating removal of the determined language.

In some examples, the prompt injection prevention component 870 may be configured to support rejecting the natural language user query.

In some examples, the prompt injection prevention component 870 may be configured to support outputting a notification indicating rejection of the natural language user query.

In some examples, to support pre-processing, the pre-processing component 850 may be configured to support parsing the natural language user query to identify personally-identifiable information. In some examples, to support pre-processing, the pre-processing component 850 may be configured to support replacing the personally-identifiable information with a placeholder value. In some examples, to support pre-processing, the pre-processing component 850 may be configured to support caching the personally-identifiable information.

In some examples, to support pre-processing, the prompt selection component 880 may be configured to support selecting, based on the natural language user query, one or more prompts. In some examples, to support pre-processing, the prompt selection component 880 may be configured to support prepending the natural language user query with the one or more prompts.

In some examples, to support selecting the one or more prompts, the prompt selection component 880 may be configured to support determining an intent associated with the natural language user query. In some examples, to support selecting the one or more prompts, the prompt selection component 880 may be configured to support selecting the one or more prompts further based on the determined intent associated with the natural language user query.

In some examples, a first prompt, of the one or more prompts, causes the machine learning model to generate the model-generated machine-readable query to query one or more: system logs, security logs, configuration logs, analytics logs, threat logs, management logs, machine access logs, browser activity logs, extended detection and response (XDR) logs, error logs, mobile device management (MDM) logs, database tables, or files.

In some examples, the post-processing component 855 may be configured to support prior to executing the model-generated machine-readable query, post-processing the model-generated machine-readable query. In some examples, the data retrieval component 835 may be configured to support where executing the model-generated machine-readable query includes executing the post-processed model-generated machine-readable query.

In some examples, the post-processing component 855 may be configured to support replacing a placeholder value embedded within the model-generated machine-readable query cached personally-identifiable information.

In some examples, the post-processing component 855 may be configured to support validating, based on a syntax associated with the machine-readable language and a schema associated with a database associated with the identity management system, the model-generated machine-readable query.

In some examples, the information responsive to the natural language user query includes one or more portions, and the output selection component 860 may be configured to support receiving a user selection of at least one portion of the one or more portions. In some examples, the information responsive to the natural language user query includes one or more portions, and the generative AI component 830 may be configured to support generating, based on the selected at least one portion and using the machine learning model, a natural language explanation of the selected at least one portion. In some examples, the information responsive to the natural language user query includes one or more portions, and the response output component 840 may be configured to support outputting the natural language explanation of the at least one portion.

In some examples, the natural language explanation includes a summarization of information associated with the at least one portion and retrieved from multiple data sources.

In some examples, the pre-processing component 850 may be configured to support prior to generating the natural language explanation of the at least one portion, pre-processing the at least one portion, where generating the natural language explanation of the at least one portion includes generating, based on the pre-processed at least one portion and using the machine learning model, the natural language explanation of the at least one portion.

In some examples, to support pre-processing the at least one portion, the context determination component 885 may be configured to support analyzing the at least one portion to determine a context associated with the at least one portion.

In some examples, to support pre-processing the at least one portion, the pre-processing component 850 may be configured to support parsing the at least one portion to identify personally-identifiable information. In some examples, to support pre-processing the at least one portion, the pre-processing component 850 may be configured to support replacing the personally-identifiable information with a placeholder value. In some examples, to support pre-processing the at least one portion, the pre-processing component 850 may be configured to support caching the personally-identifiable information.

In some examples, the post-processing component 855 may be configured to support prior to outputting the natural language explanation of the at least one portion, post-processing the natural language explanation.

In some examples, the post-processing component 855 may be configured to support post-processing by replacing a placeholder value embedded in the natural language explanation with the cached personally-identifiable information.

In some examples, to support pre-processing, the prompt selection component 880 may be configured to support selecting, based on the at least one portion, one or more prompts. In some examples, to support pre-processing, the prompt selection component 880 may be configured to support embedding the at least one portion within the one or more prompts or embedding the one or more prompts within the at least one portion.

In some examples, to support selecting the one or more prompts, the context determination component 885 may be configured to support determining a context associated with the at least one portion. In some examples, to support selecting the one or more prompts, the prompt selection component 880 may be configured to support selecting the one or more prompts further based on the determined context associated with the at least one portion.

In some examples, a second prompt, of the one or more prompts, causes the machine learning model to generate a natural language response.

In some examples, the AI training component 865 may be configured to support based on receiving a second natural language user query after outputting the information responsive to the natural language user query, training the machine learning model using the natural language user query and the second natural language user query.

In some examples, the second natural language user query is received within a predetermined amount of time after outputting the information responsive to the natural language user query.

In some examples, the AI training component 865 may be configured to support training the machine learning model to translate a natural language query into a machine-readable query.

In some examples, the information responsive to the natural language user query includes information associated with identity management data associated with the client organization, information associated with resources of the client organization, information associated with users of the client organization, information associated with groups associated with the client organization, information associated with access events associated with the client organization, information associated with authorization events associated with the client organization, information associated with a system configuration associated with the client organization, or any combination thereof.

FIG. 9 shows a diagram of a system 900 including a device 905 that supports a natural language interface for identity management data mining using generative AI in accordance with aspects of the present disclosure. The device 905 may be an example of or include the components of a device 705 as described herein. The device 905 may include components for bi-directional voice and data communications including components for transmitting and receiving communications, such as a software module 920, an I/O controller 910, a database controller 915, at least one memory 925, at least one processor 930, and a database 935. These components may be in electronic communication or otherwise coupled (e.g., operatively, communicatively, functionally, electronically, electrically) via one or more buses (e.g., a bus 940).

The I/O controller 910 may manage input signals 945 and output signals 950 for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. In other cases, the I/O controller 910 may represent or interact with a modem, a keyboard, a mouse, a touchscreen, or a similar device. In some cases, the I/O controller 910 may be implemented as part of a processor 930. In some examples, a user may interact with the device 905 via the I/O controller 910 or via hardware components controlled by the I/O controller 910.

The database controller 915 may manage data storage and processing in a database 935. In some cases, a user may interact with the database controller 915. In other cases, the database controller 915 may operate automatically without user interaction. The database 935 may be an example of a single database, a distributed database, multiple distributed databases, a data store, a data lake, or an emergency backup database.

Memory 925 may include random-access memory (RAM) and read-only memory (ROM). The memory 925 may store computer-readable, computer-executable software including instructions that, when executed, cause at least one processor 930 to perform various functions described herein. In some cases, the memory 925 may contain, among other things, a basic I/O system (BIOS) which may control basic hardware or software operation such as the interaction with peripheral components or devices. The memory 925 may be an example of a single memory or multiple memories. For example, the device 905 may include one or more memories 925.

The processor 930 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 930 may be configured to operate a memory array using a memory controller. In other cases, a memory controller may be integrated into the processor 930. The processor 930 may be configured to execute computer-readable instructions stored in at least one memory 925 to perform various functions (e.g., functions or tasks supporting natural language interface for identity data mining using generative AI). The processor 930 may be an example of a single processor or multiple processors. For example, the device 905 may include one or more processors 930.

For example, the software module 920 may be configured to support receiving, from a client device associated with a client organization, a natural language user query, where the natural language user query includes a request for information related to configuration data or a system event occurring in the identity management system and associated with the client organization. The software module 920 may be configured to support generating, based on the natural language user query and using a machine learning model, a model-generated machine-readable query, where the model-generated machine-readable query is generated in a machine-readable language associated with the identity management system. The software module 920 may be configured to support retrieving, based on executing the model-generated machine-readable query, information responsive to the natural language user query. The software module 920 may be configured to support outputting the information responsive to the natural language user query.

By including or configuring the software module 920 in accordance with examples as described herein, the device 905 may support techniques for improved user experiences related to more efficient processing and more efficient utilization of computing resources.

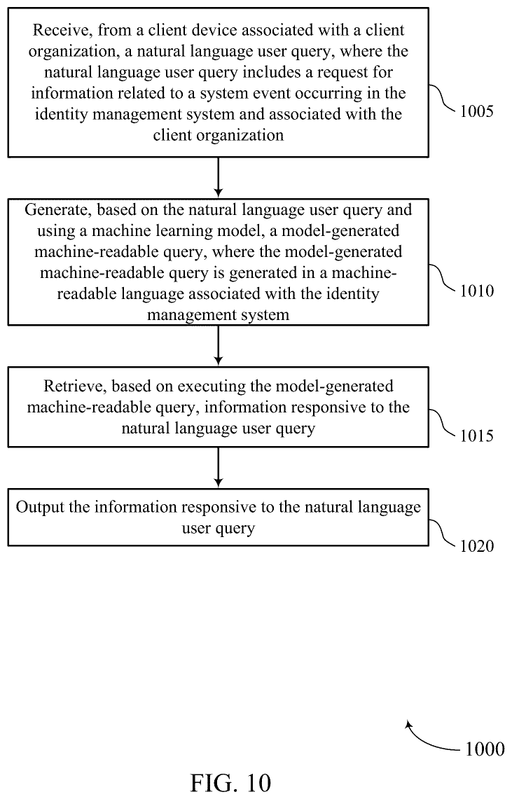

FIG. 10 shows a flowchart illustrating a method 1000 that supports a natural language interface for identity management data mining using generative AI in accordance with aspects of the present disclosure. The operations of the method 1000 may be implemented by a natural language interface system or its components as described herein. For example, the operations of the method 1000 may be performed by a natural language interface system as described with reference to FIGS. 1 through 9. In some examples, a natural language interface system may execute a set of instructions to control the functional elements of the natural language interface system to perform the described functions. Additionally, or alternatively, the natural language interface system may perform aspects of the described functions using special-purpose hardware.

At 1005, the method may include receiving, from a client device associated with a client organization, a natural language user query, where the natural language user query includes a request for information related to configuration data or a system event occurring in the identity management system and associated with the client organization. The operations of block 1005 may be performed in accordance with examples as disclosed herein. In some examples, aspects of the operations of 1005 may be performed by a user request component 825 as described with reference to FIG. 8.

At 1010, the method may include generating, based on the natural language user query and using a machine learning model, a model-generated machine-readable query, where the model-generated machine-readable query is generated in a machine-readable language associated with the identity management system. The operations of block 1010 may be performed in accordance with examples as disclosed herein. In some examples, aspects of the operations of 1010 may be performed by a generative AI component 830 as described with reference to FIG. 8.

At 1015, the method may include retrieving, based on executing the model-generated machine-readable query, information responsive to the natural language user query. The operations of block 1015 may be performed in accordance with examples as disclosed herein. In some examples, aspects of the operations of 1015 may be performed by a data retrieval component 835 as described with reference to FIG. 8.

At 1020, the method may include outputting the information responsive to the natural language user query. The operations of block 1020 may be performed in accordance with examples as disclosed herein. In some examples, aspects of the operations of 1020 may be performed by a response output component 840 as described with reference to FIG. 8.

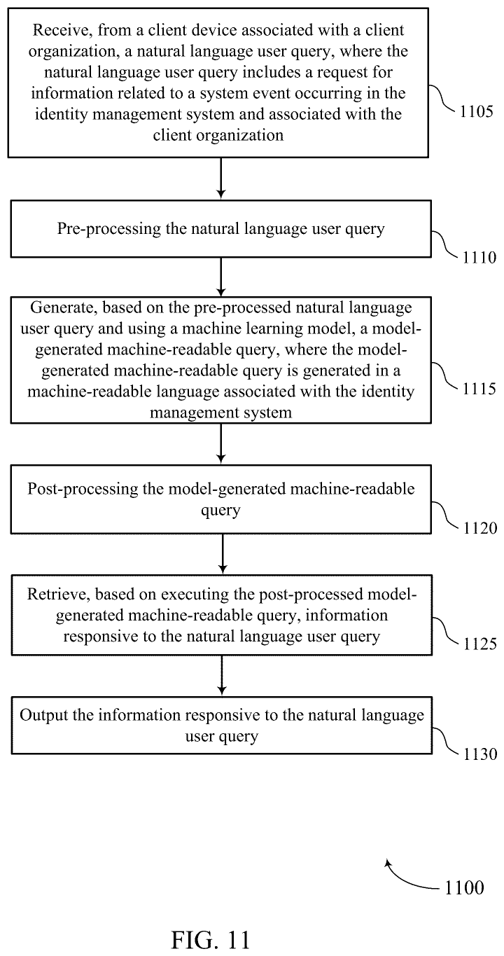

FIG. 11 shows a flowchart illustrating a method 1100 that supports a natural language interface for identity management data mining using generative AI in accordance with aspects of the present disclosure. The operations of the method 1100 may be implemented by a natural language interface system or its components as described herein. For example, the operations of the method 1100 may be performed by a natural language interface system as described with reference to FIGS. 1 through 9. In some examples, a natural language interface system may execute a set of instructions to control the functional elements of the natural language interface system to perform the described functions. Additionally, or alternatively, the natural language interface system may perform aspects of the described functions using special-purpose hardware.

At 1105, the method may include receiving, from a client device associated with a client organization, a natural language user query, where the natural language user query includes a request for information related to configuration data or a system event occurring in the identity management system and associated with the client organization. The operations of block 1105 may be performed in accordance with examples as disclosed herein. In some examples, aspects of the operations of 1105 may be performed by a user request component 825 as described with reference to FIG. 8.

At 1110, the method may include pre-processing the natural language user query. The operations of block 1110 may be performed in accordance with examples as disclosed herein. The pre-processing may include parsing the natural language user query to identify personally-identifiable information, replacing the personally-identifiable information with a placeholder value, and caching the personally-identifiable information. In some examples, aspects of the operations of 1110 may be performed by a pre-processing component 850 as described with reference to FIG. 8.

At 1115, the method may include generating, based on the pre-processed natural language user query and using a machine learning model, a model-generated machine-readable query, where the model-generated machine-readable query is generated in a machine-readable language associated with the identity management system. The operations of block 1115 may be performed in accordance with examples as disclosed herein. In some examples, aspects of the operations of 1115 may be performed by a generative AI component 830 as described with reference to FIG. 8.

At 1120, the method may include post-processing the model-generated machine-readable query. The post-processing may include replacing a placeholder value embedded in the model-generated machine-readable query with cached personally-identifiable information, and validating, based on a syntax associated with the machine-readable language and a schema associated with a database associated with the identity management system, the model-generated machine-readable query. The operations of block 1120 may be performed in accordance with examples as disclosed herein. In some examples, aspects of the operations of 1120 may be performed by a post-processing component 855 as described with reference to FIG. 8.

At 1125, the method may include retrieving, based on executing the post-processed model-generated machine-readable query, information responsive to the natural language user query. The operations of block 1125 may be performed in accordance with examples as disclosed herein. In some examples, aspects of the operations of 1125 may be performed by a data retrieval component 835 as described with reference to FIG. 8.

At 1130, the method may include outputting the information responsive to the natural language user query. The operations of block 1130 may be performed in accordance with examples as disclosed herein. In some examples, aspects of the operations of 1130 may be performed by a response output component 840 as described with reference to FIG. 8.

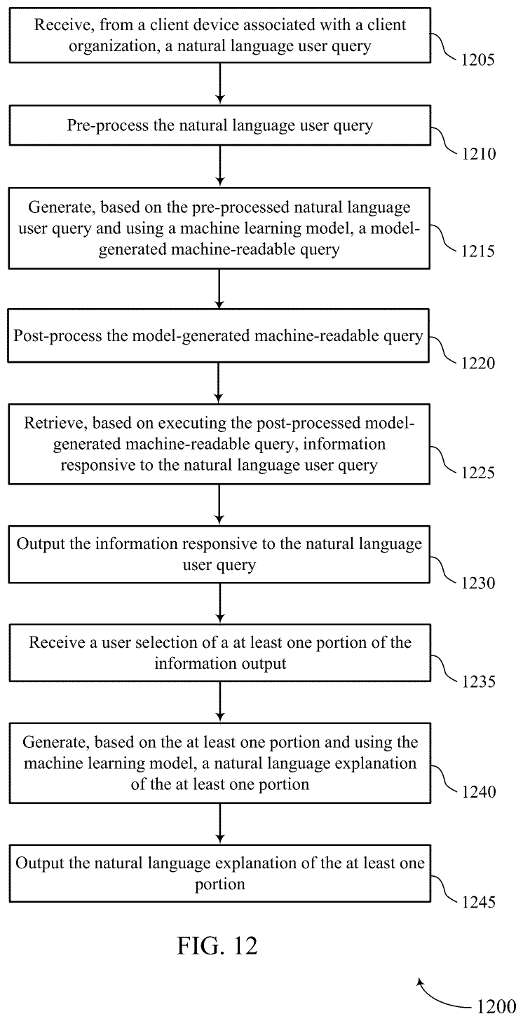

FIG. 12 shows a flowchart illustrating a method 1200 that supports a natural language interface for identity management data mining using generative AI in accordance with aspects of the present disclosure. The operations of the method 1200 may be implemented by a natural language interface system or its components as described herein. For example, the operations of the method 1200 may be performed by a natural language interface system as described with reference to FIGS. 1 through 12. In some examples, a natural language interface system may execute a set of instructions to control the functional elements of the natural language interface system to perform the described functions. Additionally, or alternatively, the natural language interface system may perform aspects of the described functions using special-purpose hardware.

At 1205, the method may include receiving, from a client device associated with a client organization, a natural language user query, where the natural language user query includes a request for information related to configuration data or a system event occurring in the identity management system and associated with the client organization. The operations of block 1205 may be performed in accordance with examples as disclosed herein. In some examples, aspects of the operations of 1205 may be performed by a user request component 825 as described with reference to FIG. 8.

At 1210, the method may include pre-processing the natural language user query. The pre-processing may include parsing the natural language user query to identify personally-identifiable information, replacing the personally-identifiable information with a placeholder value, and caching the personally-identifiable information. The operations of block 1210 may be performed in accordance with examples as disclosed herein. In some examples, aspects of the operations of 1241 may be performed by a pre-processing component 850 as described with reference to FIG. 8.

At 1215, the method may include generating, based on the pre-processed natural language user query and using a machine learning model, a model-generated machine-readable query, where the model-generated machine-readable query is generated in a machine-readable language associated with the identity management system. The operations of block 1215 may be performed in accordance with examples as disclosed herein. In some examples, aspects of the operations of 1215 may be performed by a generative AI component 830 as described with reference to FIG. 8.

At 1220, the method may include post-processing the model-generated machine-readable query. The post-processing may include replacing a placeholder value embedded in the model-generated machine-readable query with cached personally-identifiable information, and validating, based on a syntax associated with the machine-readable language and a schema associated with a database associated with the identity management system, the model-generated machine-readable query. The operations of block 1220 may be performed in accordance with examples as disclosed herein. In some examples, aspects of the operations of 1220 may be performed by a post-processing component 855 as described with reference to FIG. 8.

At 1225, the method may include retrieving, based on executing the post-processed model-generated machine-readable query, information responsive to the natural language user query. The operations of block 1225 may be performed in accordance with examples as disclosed herein. In some examples, aspects of the operations of 1225 may be performed by a data retrieval component 835 as described with reference to FIG. 8.

At 1230, the method may include outputting the information responsive to the natural language user query. The operations of block 1230 may be performed in accordance with examples as disclosed herein. In some examples, aspects of the operations of 1220 may be performed by a response output component 840 as described with reference to FIG. 8.

At 1235, the method may include receiving a user selection of at least one portion of the information output. The operations of block 1235 may be performed in accordance with examples as disclosed herein. In some examples, aspects of the operations of 1235 may be performed by a output selection component 860 as described with reference to FIG. 8.

At 1240, the method may include generating, based on the at least one portion and using the machine learning model, a natural language explanation of the at least one portion. The operations of block 1240 may be performed in accordance with examples as disclosed herein. In some examples, aspects of the operations of 1240 may be performed by a generative AI component 830 as described with reference to FIG. 8.

At 1245, the method may include outputting the natural language explanation of the at least one portion. The operations of block 1245 may be performed in accordance with examples as disclosed herein. In some examples, aspects of the operations of 1245 may be performed by a response output component 840 as described with reference to FIG. 8.

The following provides an overview of aspects of the present disclosure:

Aspect 1: A method of an identity management system, comprising: receiving, from a client device associated with a client organization, a natural language user query, wherein the natural language user query comprises a request for information related to configuration data or a system event occurring in the identity management system and associated with the client organization; generating, based at least in part on the natural language user query and using a machine learning model, a model-generated machine-readable query, wherein the model-generated machine-readable query is generated in a machine-readable language associated with the identity management system; retrieving, based at least in part on executing the model-generated machine-readable query, information responsive to the natural language user query; and outputting the information responsive to the natural language user query.

Aspect 2: The method of aspect 1, wherein the machine-readable language comprises a reporting query language (RQL), a database query language, or an expression language.

Aspect 3: The method of aspect 2, wherein the database query language comprises Structured Query Language (SQL).

Aspect 4: The method of any of aspects 2 through 3, wherein the expression language comprises OKTA Expression Language (EL), System for Cross-domain Identity Management (SCIM) filter expression, regular expression.

Aspect 5: The method of any of aspects 1 through 4, wherein the model-generated machine-readable query is generated in a first machine-readable language, wherein the method further comprises: outputting the model-generated machine-readable query in the first machine-readable language; receiving an indication of a modification to the model-generated machine-readable query; translating the modified model-generated machine-readable query from the first machine-readable language to a second machine-readable language, and wherein retrieving the information responsive to the natural language user query comprises retrieving, based at least in part on executing the modified model-generated machine-readable query in the second machine-readable language, the information responsive to the natural language user query.

Aspect 6: The method of aspect 5, wherein outputting the model-generated machine-readable query in the first machine-readable language is in response to receiving an indication of a user selection to view the model-generated machine-readable query.

Aspect 7: The method of any of aspects 5 through 6, wherein the translating comprises compiling the modified model-generated machine-readable query in the first machine-readable language to generate the modified model-generated machine-readable query in the second machine-readable language.

Aspect 8: The method of any of aspects 5 through 7, wherein the first machine-readable language comprises RQL.

Aspect 9: The method of any of aspects 5 through 8, wherein the second machine-readable language comprises SQL.

Aspect 10: The method of any of aspects 1 through 9, wherein the model-generated machine-readable query, when executed, retrieves the information from one or more: system logs, security logs, configuration logs, analytics logs, threat logs, management logs, machine access logs, browser activity logs, extended detection and response (XDR) logs, error logs, mobile device management (MDM) logs, database tables, or files.

Aspect 11: The method of aspect 1, wherein the retrieved information comprises the information related to the configuration data or the system event occurring in the identity management system.

Aspect 12: The method of any of aspects 1 through 11, wherein the model-generated machine-readable query, when executed, retrieves the information from one or more report tables.

Aspect 13: The method of aspect 12, wherein the one or more report tables comprise the information related to the configuration data or the system event occurring in the identity management system.

Aspect 14: The method of any of aspects 1 through 13, further comprising: prior to generating the model-generated machine-readable query, pre-processing the natural language user query, wherein generating the model-generated machine-readable query comprises generating, based at least in part on the pre-processed natural language user query and using the machine learning model, the model-generated machine-readable query.

Aspect 15: The method of aspect 14, wherein the pre-processing comprises: parsing the natural language user query to determine whether the natural language user query comprises: language that is potentially malicious, or language that violates a constraint configured by the identity management system.

Aspect 16: The method of aspect 15, further comprising: removing the determined language.

Aspect 17: The method of aspect 16, further comprising: outputting a notification indicating removal of the determined language.

Aspect 18: The method of any of aspects 15 through 17, further comprising: rejecting the natural language user query.

Aspect 19: The method of aspect 18, further comprising outputting a notification indicating rejection of the natural language user query.

Aspect 20: The method of any of aspects 14 through 19, wherein the pre-processing comprises: parsing the natural language user query to identify personally-identifiable information; replacing the personally-identifiable information with a placeholder value; and caching the personally-identifiable information.

Aspect 21: The method of any of aspects 14 through 20, wherein the pre-processing comprises: selecting, based at least in part on the natural language user query, one or more prompts; and embedding the natural language user query within the one or more prompts or embedding the one or more prompts within the natural language user query.

Aspect 22: The method of aspect 21, wherein selecting the one or more prompts comprises: determining an intent associated with the natural language user query; and selecting the one or more prompts further based at least in part on the determined intent associated with the natural language user query.

Aspect 23: The method of any of aspects 21 through 22, wherein a first prompt, of the one or more prompts, causes the machine learning model to generate the model-generated machine-readable query to query one or more: system logs, security logs, configuration logs, analytics logs, threat logs, management logs, machine access logs, browser activity logs, extended detection and response (XDR) logs, error logs, mobile device management (MDM) logs, database tables, or files.

Aspect 24: The method of any of aspects 1 through 23, further comprising: prior to executing the model-generated machine-readable query, post-processing the model-generated machine-readable query; and wherein executing the model-generated machine-readable query comprises executing the post-processed model-generated machine-readable query.

Aspect 25: The method of aspect 24, wherein the pre-processing comprises: replacing the placeholder value with the cached personally-identifiable information.

Aspect 26: The method of aspect 24, wherein the pre-processing comprises: validating, based at least in part on a syntax associated with the machine-readable language and a schema associated with a database associated with the identity management system, the model-generated machine-readable query.

Aspect 27: The method of any of aspects 1 through 24, wherein the information responsive to the natural language user query comprises one or more portions, wherein the outputting comprises outputting the one or more portions, and wherein the method further comprises: receiving a user selection of at least one portion of the one or more portions; generating, based at least in part on the at least one portion and using the machine learning model, a natural language explanation of the at least one portion; and outputting the natural language explanation of the at least one portion.

Aspect 28: The method of any of aspects 1 through 24, wherein the information responsive to the natural language user query comprises one or more portions, wherein the outputting comprises outputting the one or more portions, and wherein the method further comprises: receiving a user selection of a plurality of portions of the one or more portions; generating, based at least in part on the plurality of portions and using the machine learning model, a natural language explanation of the plurality of portions; and outputting the natural language explanation of the plurality of portions.

Aspect 29: The method of aspect 27, wherein the natural language explanation comprises a summarization of information associated with the at least one portion and retrieved from a plurality of data sources.

Aspect 30: The method of any of aspects 27 through 29, further comprising: prior to generating the natural language explanation of the at least one portion, pre-processing the at least one portion, wherein generating the natural language explanation of the at least one portion comprises generating, based at least in part on the pre-processed at least one portion and using the machine learning model, the natural language explanation of the at least one portion.

Aspect 31: The method of aspect 30, wherein pre-processing the at least one portion comprises: analyzing the at least one portion to determine a context associated with the at least one portion.

Aspect 32: The method of any of aspects 30 through 31, wherein pre-processing the at least one portion comprises: parsing the at least one portion to identify personally-identifiable information; replacing the personally-identifiable information with a placeholder value; and caching the personally-identifiable information.

Aspect 33: The method of aspect 32, further comprising: prior to outputting the natural language explanation of the at least one portion, replacing the placeholder value with the cached personally-identifiable information.

Aspect 34: The method of any of aspects 30 through 33, wherein the pre-processing comprises: selecting, based at least in part on the at least one portion, one or more prompts; and prepending the at least one portion with the one or more prompts.

Aspect 35: The method of aspect 34, wherein selecting the one or more prompts comprises: determining a context associated with the at least one portion; and selecting the one or more prompts further based at least in part on the determined context associated with the at least one portion.

Aspect 36: The method of any of aspects 34 through 35, wherein a second prompt, of the one or more prompts, causes the machine learning model to generate a natural language response.

Aspect 37: The method of any of aspects 1 through 36, further comprising: based at least in part on receiving a second natural language user query after outputting the information responsive to the natural language user query, training the machine learning model using the natural language user query and the second natural language user query.

Aspect 38: The method of aspect 37, wherein the second natural language user query is received within a predetermined amount of time after outputting the information responsive to the natural language user query.

Aspect 39: The method of any of aspects 1 through 38, further comprising: training the machine learning model to translate a natural language query into a machine-readable query.

Aspect 40: The method of any of aspects 1 through 39, wherein the information responsive to the natural language user query comprises information associated with identity management data associated with the client organization, information associated with resources of the client organization, information associated with users of the client organization, information associated with groups associated with the client organization, information associated with access events associated with the client organization, information associated with authorization events associated with the client organization, information associated with a system configuration associated with the client organization, or any combination thereof.

Aspect 41: An device comprising one or more memories storing processor-executable code, and one or more processors coupled with the one or more memories and individually or collectively operable to execute the code to cause the device to perform a method of any of aspects 1 through 40.

Aspect 42: An device comprising at least one means for performing a method of any of aspects 1 through 40.

Aspect 43: A non-transitory computer-readable medium storing code the code comprising instructions executable by a processor to perform a method of any of aspects 1 through 40.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations, and does not represent all the examples that may be implemented, or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by one or more processors, firmware, or any combination thereof. If implemented in software executed by one or more processors, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method of an identity management system, comprising:
receiving, from a client device associated with a client organization, a natural language user query, wherein the natural language user query comprises a request for information related to configuration data or a system event occurring in the identity management system and associated with the client organization;
generating, based at least in part on the natural language user query and using a machine learning model, a model-generated machine-readable query, wherein the model-generated machine-readable query is generated in a machine-readable language associated with the identity management system;
retrieving, based at least in part on executing the model-generated machine-readable query, information responsive to the natural language user query; and
outputting the information responsive to the natural language user query.

2. The method of claim 1, wherein the model-generated machine-readable query is generated in a first machine-readable language, wherein the method further comprises:
outputting the model-generated machine-readable query in the first machine-readable language;
receiving an indication of a modification to the model-generated machine-readable query; and
translating the modified model-generated machine-readable query from the first machine-readable language to a second machine-readable language,
wherein retrieving the information responsive to the natural language user query comprises retrieving, based at least in part on executing the modified model-generated machine-readable query in the second machine-readable language, the information responsive to the natural language user query.

3. The method of claim 2, wherein translating the modified model-generated machine-readable query comprises compiling the modified model-generated machine-readable query in the first machine-readable language to generate the modified model-generated machine-readable query in the second machine-readable language.

4. The method of claim 1, wherein the retrieved information comprises the information related to the configuration data or the system event occurring in the identity management system.

5. The method of claim 1, further comprising:
prior to generating the model-generated machine-readable query, pre-processing the natural language user query,
wherein generating the model-generated machine-readable query comprises generating, based at least in part on the pre-processed natural language user query and using the machine learning model, the model-generated machine-readable query.

6. The method of claim 5, wherein pre-processing the natural language user query comprises:
parsing the natural language user query to determine whether the natural language user query comprises:
language that is potentially malicious, or
language that violates a constraint configured by the identity management system.

7. The method of claim 6, further comprising:
removing the determined language; or
rejecting the natural language user query.

8. The method of claim 5, wherein pre-processing the natural language user query comprises:
parsing the natural language user query to identify personally-identifiable information;
replacing the personally-identifiable information with a placeholder value; and
caching the personally-identifiable information.

9. The method of claim 5, wherein pre-processing the natural language user query comprises:
determining an intent associated with the natural language user query;
selecting, based at least in part on the determined intent associated with the natural language user query, one or more prompts; and
embedding the natural language user query within the one or more prompts wherein a first prompt, of the one or more prompts, causes the machine learning model to generate the model-generated machine-readable query to query one or more: system logs, security logs, configuration logs, analytics logs, threat logs, management logs, machine access logs, browser activity logs, extended detection and response (XDR) logs, error logs, mobile device management (MDM) logs, database tables, or files.

10. The method of claim 1, further comprising:
prior to executing the model-generated machine-readable query, post-processing the model-generated machine-readable query,
wherein executing the model-generated machine-readable query comprises executing the post-processed model-generated machine-readable query.

11. The method of claim 10, wherein post-processing the model-generated machine-readable query comprises:
replacing a placeholder value embedded in the model-generated machine-readable with cached personally-identifiable information.

12. The method of claim 10, wherein post-processing the model-generated machine-readable query comprises:
validating, based at least in part on a syntax associated with the machine-readable language and a schema associated with a database associated with the identity management system, the model-generated machine-readable query.

13. The method of claim 1, wherein the information responsive to the natural language user query comprises one or more portions, wherein outputting the information comprises outputting the one or more portions, and wherein the method further comprises:
receiving a user selection of at least one portion of the one or more portions;
generating, based at least in part on the selected at least one portion and using the machine learning model, a natural language explanation of the selected at least one portion; and
outputting the natural language explanation of the selected at least one portion.

14. The method of claim 13, wherein the natural language explanation comprises a summarization of information associated with the at least one portion and retrieved from a plurality of data sources.

15. The method of claim 1, wherein the information responsive to the natural language user query comprises information associated with identity management data associated with the client organization, information associated with resources of the client organization, information associated with users of the client organization, information associated with groups associated with the client organization, information associated with access events associated with the client organization, information associated with authorization events associated with the client organization, information associated with a system configuration associated with the client organization, or any combination thereof.

16. The method of claim 1, further comprising:
training the machine learning model to translate a natural language query into a machine-readable query.

17. An device associated with an identity management system, comprising:
one or more memories storing processor-executable code; and
one or more processors coupled with the one or more memories and individually or collectively operable to execute the code to cause the device to:
receive, from a client device associated with a client organization, a natural language user query, wherein the natural language user query comprises a request for information related to configuration data or a system event occurring in the identity management system and associated with the client organization;
generate, based at least in part on the natural language user query and on a machine learning model, a model-generated machine-readable query, wherein the model-generated machine-readable query is generated in a machine-readable language associated with the identity management system;
retrieve, based at least in part on execution of the model-generated machine-readable query, information responsive to the natural language user query; and
output the information responsive to the natural language user query.

18. The device of claim 17, wherein the model-generated machine-readable query is generated in a first machine-readable language, and wherein the one or more processors are individually or collectively operable to execute the code to further cause the device to:
output the model-generated machine-readable query in the first machine-readable language;
receive an indication of a modification to the model-generated machine-readable query;
translate the modified model-generated machine-readable query from the first machine-readable language to a second machine-readable language, and
retrieve the information responsive to the natural language user query based at least in part on execution of the modified model-generated machine-readable query in the second machine-readable language.

19. The device of claim 18, wherein, to translate the modified model-generated machine-readable query, the one or more processors are individually or collectively operable to execute the code to cause the device to:
compile the modified model-generated machine-readable query in the first machine-readable language to generate the modified model-generated machine-readable query in the second machine-readable language.

20. A non-transitory computer-readable medium storing code, the code comprising instructions executable by one or more processors of a device associated with an identity management system to perform:
receiving, from a client device associated with a client organization, a natural language user query, wherein the natural language user query comprises a request for information related to configuration data or a system event occurring in the identity management system and associated with the client organization;
generating, based at least in part on the natural language user query and using a machine learning model, a model-generated machine-readable query, wherein the model-generated machine-readable query is generated in a machine-readable language associated with the identity management system;
retrieving, based at least in part on executing the model-generated machine-readable query, information responsive to the natural language user query; and
outputting the information responsive to the natural language user query.
